(19) United States
(12) Patent Application Publication
(10) Pub. No.: US 2019/0240661 A1
(43) Pub. Date: Aug. 8, 2019

(54) CARTRIDGE AND ANALYSIS SYSTEM FOR TESTING A SAMPLE

(71) Applicant: BOEHRINGER INGELHEIM VETMEDICA GMBH, Ingelheim am Rhein (DE)

(72) Inventors: Matthias KRONSBEIN, Kaiserslautern (DE); Lutz WEBER, Zweibruecken (DE); Guenter BRUCKMANN, Wuerselen (DE); Harald PAULS, Eschweiler (DE); Hannah SCHMOLKE, Didderse (DE)

(73) Assignee: BOEHRINGER INGELHEIM VETMEDICA GMBH, Ingelheim am Rhein (DE)

(21) Appl. No.: 16/339,026

(22) PCT Filed: Oct. 5, 2017
(86) PCT No.: PCT/EP2017/025293

§ 371 Date: Apr. 3, 2019

(30) Foreign Application Priority Data
Oct. 7, 2016 (EP) 16020385.7

(51) Int. Cl. B01L 3/00

(52) U.S. Cl. CPC B01L 3/502715; B01L 3/50273; B01L 2200/027; B01L 2300/0816; B01L 2300/0887; B01L 2400/06; B01L 2400/0475; B01L 2200/0689

(57) ABSTRACT

A cartridge and an analysis system for testing a sample, and, in particular, a biological sample are provided, wherein the cartridge includes a connection for a working medium and a planar seal in order to seal the connection while the working medium is being fed into a manipulating apparatus. In embodiments, the cartridge and analysis system includes a pump apparatus for conveying the sample, the pump apparatus including a pump chamber that is elastically deformable by means of a pump head.

### BACKGROUND OF THE INVENTION

### Field of the Invention

The present invention relates to a cartridge for analysing and/or testing a sample, and, in particular, a biological sample and to an analysis system for testing such a sample.

Preferably, the present invention deals with analysing and testing a sample, in particular from a human or animal, particularly preferably for analytics and diagnostics, for example with regard to the presence of diseases and/or pathogens and/or for determining blood counts, antibodies, hormones, steroids or the like. Therefore, the present invention is in particular within the field of bioanalytics. A food sample, environmental sample or another sample may optionally also be tested, in particular for environmental analytics or food safety and/or for detecting other substances.

Preferably, at least one analyte (target analyte) of a sample can be determined, identified or detected by means of the cartridge. In particular, the sample can be tested for qualitatively or quantitatively determining at least one analyte, for example in order for it to be possible to detect or identify a disease and/or pathogen.

Within the meaning of the present invention, analytes are in particular nucleic-acid sequences, in particular DNA sequences and/or RNA sequences, or proteins, in particular antigens and/or antibodies. In particular, by means of the present invention, nucleic-acid sequences can be determined, identified or detected as analytes of a sample, or proteins can be determined, identified or detected as analytes of the sample. More particularly preferably, the present invention deals with systems, devices and other apparatuses for carrying out a nucleic-acid assay for detecting or identifying a nucleic-acid sequence or a protein assay for detecting or identifying a protein.

The present invention deals in particular with what are known as point-of-care systems, i.e. those with the option of carrying out tests on site and/or independently from a central laboratory or the like. Preferably, point-of-care systems can be operated autonomously and/or independently of a mains network for supplying electrical power.

### Description of the Related Art

U.S. Pat. No. 5,096,669 discloses a point-of-care system for testing a biological sample, in particular a blood sample. The system comprises a single-use cartridge and an analysis device. The cartridge comprises a receptacle for the sample, it being possible for the receptacle to be closed by a cap once the sample has been received. The cartridge is then inserted into the analysis device in order to carry out the test. The cartridge comprises a microfluidic system and a sensor apparatus comprising electrodes, which apparatus is calibrated by means of a calibration liquid and is then used to test the sample. A waste cavity for receiving liquids is fluidically connected to the sensor apparatus.

Furthermore, International Publication No. WO 2006/125767 A1 and corresponding U.S. Pat. No. 9,110,044 B2 disclose a point-of-care system for integrated and automated DNA or protein analysis, comprising a single-use cartridge, an analysis device comprising a control device and comprising means for receiving and processing signals, the control device being designed to fully automatically process and evaluate molecular-diagnostic analyses using the single-use cartridge.

DE Patent No. 10 2013 222 283 B3 and corresponding US Patent Application Publication No. 2016/0263573 A1 disclose a microfluidic device for performing an immunoassay, the device comprising several fluidically connected chambers. A fluid in the device can be moved by deflection of a membrane through applied pressure. An optional covering layer surrounding a fluidic connection to the membrane is provided.

US Patent Application Publication No. 2010/0221814 A1 discloses an analysis device for performing DNA analysis. The analysis device comprises a plurality of pressurising holes, shutter pressurising holes, shutter ports and shutter channels. A pressure medium such as pressurised air can be applied to the shutter ports so that shutter channels can be opened or closed. By this mechanism, a sample to be analysed can be moved through the analysis device. The pressurising holes and the shutter pressurising holes are sealed by gaskets formed by O-rings.

US Patent Application Publication No. 2014/0377146 A1 discloses a pneumatically driven portable assay cartridge with microfluidic channels. A pneumatic interface to the cartridge is formed by a boss pressing against a membrane which defines a planer compliant surface for engagement with a narrow lip of the boss.

International Publication No. WO 2015/191916 A1 and corresponding US Patent Application Publication No. 2017/0113221 A1 disclose a microfluidic cartridge and apparatus with integrated assay controls for analysis of nucleic acids. The cartridge can comprise an array of pneumatic ports for receiving pneumatic pulses that are connected to a pneumatic circuit in a housing of the cartridge and which control the operation of pneumohydraulic membranes. The cartridge comprises a gasket for interfacing with a pneumatic interface multiport of a host instrument.

Usually, pumps, such as peristaltic pumps, are used to convey the sample in point-of-care systems of this kind. For example, EP Patent No. 1 829 568 B1 and corresponding U.S. Pat. No. 8,079,836 B2 disclose a method for operating a peristaltic pump having a roller head which supports a plurality of rollers, the roller head being brought into contact with a flexible fluid channel of a cassette and being rotated such that a plurality of rollers contact the fluid channel and cause fluid to flow through the fluid channel.

Furthermore, DE Patent No. 10 2011 015 184 B4 and corresponding U.S. Pat. No. 8,950,424 B2 disclose a microfluidic instrument for transporting a fluid, comprising a plurality of films that abut one another by means of opposing film surfaces and are interconnected so as to define a transport channel to be formed between the films, a manipulating apparatus being provided in order to form the transport channel by jointly deflecting the films.

### SUMMARY OF THE INVENTION

The problem addressed by the present invention is to provide an improved cartridge and analysis system for testing and/or analysing an in particular biological sample, with reliable, simple, gentle, hygienic and/or cost-effective testing of the sample and/or a compact and/or cost-effective design of the cartridge preferably being made possible or facilitated.

The above problem is solved by a cartridge for testing a sample, the cartridge including a main body and a fluid system having a plurality of channels, a manipulating apparatus that is flexible at least in part, and a working medium for actuating the manipulating apparatus to supply the working medium, the cartridge also including a planar seal to seal a fluidic connection between a connection and an analysis device. The above problem can also be solved by a cartridge for testing a sample, the cartridge including a fluid system having a plurality of channels, a valve for controlling a flow of the sample, a manipulating apparatus that is flexible at least in part, a working medium for actuating the manipulating apparatus to supply the working medium, wherein the cartridge also includes a seal to seal a fluidic connection between a connection and an analysis device, the valve including a cover or layer covering a wall of the valve. The above problem is also solved by a cartridge for testing a sample, the cartridge including a fluid system having a plurality of channels, a pump apparatus including a deformable pump chamber, and a manipulating apparatus to raise a wall of the pump chamber. The above problem is also solved by an analysis system including a cartridge for receiving the sample, and an analysis device for performing the testing, the cartridge including a fluid system with a plurality of channels and cavities and a pump apparatus to convey the sample, the pump apparatus including a pump chamber that is elastically deformable or compressible by means of a pump head to convey the sample, and/or an actuator to actuate a manipulating element of the cartridge to increase pressure in the cartridge.

The proposed cartridge preferably comprises a manipulating or deflecting apparatus, which is in particular flexible and/or deformable at least in part, a working medium, in particular gas, particularly preferably air, preferably being or being able to be admitted to the manipulating apparatus and/or the manipulating apparatus preferably being or being able to be driven by said working medium.

The cartridge preferably comprises a connection by means of which, in particular from the outside, the cartridge or manipulating apparatus can be supplied with, pressurised by and/or driven by the working medium and/or by means of which the working medium can be admitted to the cartridge or manipulating apparatus.

One aspect of the present invention is that, in particular in order to seal the connection while the working medium is being fed in, the cartridge comprises or forms, in particular around the connection and/or in the region of the connection, a seal which is in particular planar and particularly preferably flexible at least in part. More particularly preferably, the seal is made of a foamed plastics material and/or is connected to a support or main body of the cartridge in a bonded manner, in particular by adhesion.

In another aspect of the present invention, which can also be implemented independently, the cartridge comprises a seal in other to seal a fluidic connection between the connection of the cartridge and an analysis device. Further, a valve of the cartridge for controlling the flow of the sample or another fluid within the cartridge comprises a cover or layer covering a wall or film of the valve on a side remote from a valve chamber, wherein the cover or layer is made of the same material or in one piece with the seal.

The cartridge preferably comprises a pump apparatus for conveying the sample and/or a fluid, the pump apparatus comprising a pump chamber having a wall that is flexible at least in part, and/or it being possible for the sample and/or the fluid to be conveyed by deforming the wall. The manipulating apparatus is provided for the pump apparatus or pump chamber, in order to deflect the pump chamber or the wall thereof and/or to enlarge said chamber or wall again following deformation.

Another aspect of the present invention, which can also be implemented independently, is that an analysis device is or can be linked or connected fluidically, in particular pneumatically, to a cartridge or the manipulating apparatus thereof.

In particular, a working medium is provided for the cartridge or the manipulating apparatus, externally or outside said cartridge or manipulating apparatus. This allows or facilitates secure, simple and/or reliable conveying of fluid by means of the pump. It is in particular possible for a working medium for the cartridge or manipulating apparatus to be pressurised outside the cartridge, and therefore no instruments are provided on and/or in the cartridge for pressurising the working medium. Advantageously, the complexity of the cartridge is thus reduced and/or a compact construction or design thereof is made possible or facilitated.

According to another aspect of the present invention, which can also be implemented independently, an analysis device or analysis system is designed to supply the cartridge and/or the manipulating apparatus with a working medium. In particular, the analysis device or analysis system according to the invention comprises a pressurised gas supply or pressure generator, such as a compressor, in order to pressurise the working medium. This results in corresponding advantages.

According to another aspect of the present invention, which can also be implemented independently, the manipulating apparatus of the cartridge comprises a distribution channel and a plurality of feed channels, it being possible for a working medium to be fed from the distribution channel to a pressure chamber of the manipulating apparatus via the feed channels, the distribution channel being arranged directly below the pressure chamber in a plan view of the cartridge. This allows or facilitates even distribution of the working medium and/or even admittance of the working medium to the pressure chamber and/or even deflection of the pump chamber.

According to another aspect of the present invention, which can also be implemented independently, the cartridge comprises a sensor apparatus for testing the sample or a component thereof, the manipulating apparatus, in particular the pressure chamber thereof, being arranged directly below the sensor apparatus in a plan view of the cartridge, and/or being designed to hold the sample and/or a fluid on the sensor apparatus at least temporarily and/or in portions and/or to seal the sensor apparatus at least temporarily and/or in portions. This makes it possible for the sample or a component thereof to be held on or in the sensor apparatus for the time required for the test, for required reaction times to be observed and/or for the sample or a component thereof to be prevented from flowing past or through the sensor apparatus in an uncontrolled manner In particular, a manipulating apparatus of this kind makes it possible to test the sample in a controlled manner.

According to a further aspect of the present invention, which can also be implemented independently, the cartridge or manipulating apparatus comprises a manipulating element acting on a fluid system of the cartridge for increasing the pressure in the pump chamber of the cartridge to raise the pump chamber or a respective wall thereof when the manipulating element is actuated or depressed. This allows a very simple construction and secure return of the pump chamber.

The proposed analysis system preferably comprises a proposed analysis device and at least one cartridge for the sample. In particular, the analysis system is designed as a kit comprising the analysis device and at least one cartridge.

According to a further aspect of the present invention, which can be realized independently, the analysis system or method for testing a sample actuates or depresses a preferably membrane-like manipulation element to increase the pressure acting in the fluid system or the pump chamber so as to return the deformable pump chamber towards its non-deformed shape. This allows a very simple and cost-effective realisation and secure return of the pump chamber and, thus, defined and effective pumping.

A kit within the meaning of the present invention is preferably a group and/or analysis system comprising the analysis device and/or at least one cartridge. The analysis device and/or the cartridge preferably each form a component of the kit.

The components of the kit are preferably marketed as a group, in particular in the same packaging or the like. It is however also possible for the aforementioned components to form a group of separate components for joint use. A common or unifying component is preferably provided, for example common operating instructions, recommendations for use or references on the labelling of one or more of the components of the kit and/or the common packaging. The proposed analysis system or kit optionally comprises at least a pair of gloves, operating instructions, a transfer apparatus such as a syringe, pipette or the like, and/or an extractant or solvent.

The term “analysis device” is preferably understood to mean a structural apparatus designed to chemically, biologically and/or physically test and/or analyse a sample or analysis sample or a component thereof, in particular in order for it to be possible to directly and/or indirectly detect or identify a disease -and/or pathogen. An analysis device within the meaning of the present invention is in particular a portable or mobile device designed to directly test and/or analyse the sample, in particular on site and/or in the vicinity of the sampling site and/or away from a central laboratory.

The term “cartridge” is preferably understood to mean a structural apparatus or unit designed to receive, to store, to physically, chemically and/or biologically treat and/or to measure a preferably biological sample. A cartridge within the meaning of the present invention preferably comprises a fluidic system or fluid system having a plurality of channels, cavities and/or valves for controlling the flow through the channels and/or cavities. In particular, within the meaning of the present invention, a cartridge is designed to be at least substantially planar, flat and/or card-like, in particular is designed as a fluidic card and/or is designed as a support or main body and/or container for the sample that can be inserted and/or plugged into the proposed analysis device.

The term “manipulating apparatus” is preferably understood to mean a structural apparatus or unit of the cartridge that is designed to actuate, pressurise, deflect and/or seal components of the cartridge, such as the pump apparatus and/or sensor apparatus. Within the meaning of the present invention, a manipulating apparatus preferably comprises at least one manipulating element and/or a pressure chamber, it preferably being possible for the manipulating element to be moved and/or deflected by means of a working medium and/or for the pressure chamber to be pressurised and/or enlarged by means of the working medium. Preferably, the manipulating element forms a wall of the pressure chamber and/or the manipulating element is connected to a wall of the pressure chamber.

The proposed analysis device preferably comprises a receptacle for a cartridge containing a sample. In particular, the cartridge containing the sample can be inserted into the analysis device in order for the sample to be analysed. It is however also possible for the cartridge to be connected or connectable to the analysis device in another manner For example, the cartridge can also be put on or next to the analysis device or attached to the side of the analysis device.

The method according to the invention for testing an in particular biological sample is characterised according to another aspect in that a working medium is pressurised by an analysis device and fed to a cartridge or a manipulating apparatus thereof, and/or the analysis device is linked fluidically, in particular pneumatically, to a cartridge once said cartridge has been received, in order to admit the working medium to the manipulating apparatus or a pressure chamber of the manipulating apparatus and/or to pressurise said manipulating apparatus or pressure chamber. This results in corresponding advantages.

The above-mentioned aspects and features of the present invention and the aspects and features of the present invention that will become apparent from the claims and the following description can in principle be implemented independently from one another, but also in any combination.

Other aspects, advantages, features and properties of the present invention will become apparent from the claims and the following description of preferred embodiments with reference to the accompanying drawings.

### BRIEF DESCRIPTION OF THE DRAWINGS

FIG. 1 is a schematic plan view of a proposed cartridge;

FIG. 2 is a schematic section through the cartridge in the region of a receptacle or receiving cavity for a sample in the open state, with a transfer apparatus connected;

FIG. 3 is a schematic view of a proposed analysis system comprising the cartridge according to FIG. 1 and a proposed analysis device;

FIG. 4 is a schematic view of a detail of the back of the cartridge according to FIG. 1;

FIG. 5 is a schematic section through the cartridge along the sectional line V-V according to FIG. 4;

FIG. 6 is a schematic section through the cartridge according to FIG. 5 when actuated;

FIG. 7 is a schematic section through the cartridge along the sectional line VII-VII according to FIG. 4;

FIG. 8 is a schematic section through the cartridge according to FIG. 7 when actuated;

FIG. 9 is a perspective view of a proposed pump head of the analysis device according to FIG. 3;

FIG. 10 is a schematic section through a proposed pump according to a first embodiment;

FIG. 11 is a schematic section through a proposed pump according to a second embodiment;

FIG. 12 is a schematic plan view of a proposed pump according to a third embodiment;

FIG. 13 is a schematic section through the pump according to FIG. 12;

FIG. 14 is a schematic section through the cartridge according to FIG. 1 in the region of a connection together with a connection apparatus of which a detail is shown;

FIG. 15 is a schematic section through the cartridge according to FIG. 14 when connected; and

FIG. 16 is a schematic view of the proposed analysis system comprising the cartridge and the proposed analysis device according to a further aspect or another embodiment.

### DETAILED DESCRIPTION OF THE INVENTION

In the following description, the same reference signs are used for the same and similar parts and components, resulting in corresponding properties and features even if these are not repeatedly described.

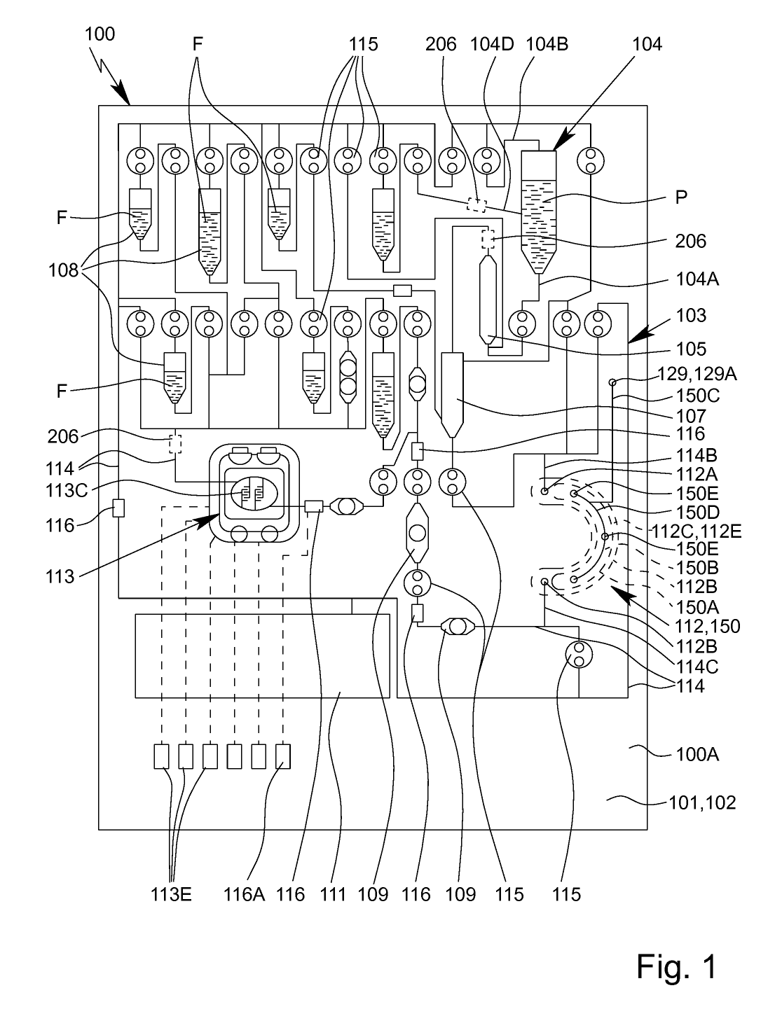

FIG. 1 is a highly schematic view of a preferred embodiment of a proposed cartridge 100 for testing an in particular biological sample P.

The term “sample” is preferably understood to mean the sample material to be tested, which is in particular taken from a human or animal. In particular, within the meaning of the present invention, a sample is a fluid, such as saliva, blood, urine or another liquid, preferably from a human or animal, or a component thereof. Within the meaning of the present invention, a sample may be pretreated or prepared if necessary, or may come directly from a human or animal or the like, for example. A food sample, environmental sample or another sample may optionally also be tested, in particular for environmental analytics, food safety and/or for detecting other substances, preferably natural substances, but also biological or chemical warfare agents, poisons or the like.

A sample within the meaning of the present invention preferably contains one or more analytes, it preferably being possible for the analytes to be identified or detected, in particular qualitatively and/or quantitatively determined. Particularly preferably, within the meaning of the present invention, a sample has target nucleic-acid sequences as the analytes, in particular target DNA sequences and/or target RNA sequences, and/or target proteins as the analytes, in particular target antigens and/or target antibodies. Particularly preferably, at least one disease and/or pathogen can be detected or identified in the sample P by qualitatively and/or quantitatively determining the analytes.

The cartridge 100 comprises a receptacle or receiving cavity 104 for the sample P. Further details will be given later on a preferred construction of this receptacle or receiving cavity 104.

The cartridge 100 comprises a fluidic, preferably microfluidic, system 103, referred to in the following as the fluid system 103, which is fluidically connected to the receptacle or receiving cavity 104.

The cartridge 100 and/or the fluid system 103 preferably comprises at least one pump apparatus 5, at least one storage cavity 108 for a reagent, in the example shown in particular a plurality of storage cavities 108 for different liquid reagents F, at least one measuring or metering cavity 105, at least one mixing cavity 107, at least one treatment or reaction cavity 109, a collection or equalisation cavity 111 and/or at least one sensor apparatus 113.

The cartridge 100 and/or the fluid system 103 in particular comprises channels 114, valves 115 and/or sensors or sensor portions 116.

Particularly preferably, the fluid system 103 is formed by the cavities 105, 107 to 109, 111 and the channels 114.

The channels 114 are preferably designed to fluidically interconnect the receptacle or receiving cavity 104, the pump apparatus 5, the cavities 105, 107 to 109, 111 and/or the sensor apparatus 113 and/or to connect these as desired and/or selectively.

The valves 115 are preferably designed to control, in particular to allow, to prevent, to reduce and/or to increase, preferably temporarily or permanently as desired, the flow rate or fluid flows, in particular of the sample P and/or of the reagent F or reagents F and/or of gas or air, through the channels 114, cavities 105, 107 to 109, 111, the pump apparatus 5, the sensor apparatus 113 and/or the sensors or sensor portions 116, as explained in greater detail in the following.

The cartridge 100 preferably comprises an in particular at least substantially planar, flat, plate-shaped and/or card-like support or main body 101, the support or main body 101 preferably being made of and/or injection-moulded from plastics material.

The cartridge 100 preferably comprises two flat sides 100A, 100B and/or the front 100A and the back 100B of the cartridge 100 are each a flat side of the in particular planar and/or card-like cartridge 100,

FIG. 1 shows the front 100A of the cartridge 100,

Preferably, the front 100A of the cartridge 100 is at least substantially flat or planar and/or is an at least substantially flat or planar side of the cartridge 100,

Preferably, the back 100B of the cartridge 100 is opposite the front 100A.

The back 100B of the cartridge 100 is preferably uneven and/or is an uneven side of the cartridge 100. However, other solutions are also possible in which the back 100B is flat or planar.

Preferably, the cavities 105, 107 to 109, 111, the channels 114, the valves 115 and/or the pump apparatus 112 are formed by corresponding depressions and/or raised portions in the support or main body 101.

More particularly preferably, the cartridge 100 comprises a layer, cover or film 102, which is always referred to as film or cover 102 in the following, the support or main body 101 preferably being connected at least in part to the film or cover 102, in particular in a bonded manner, and/or being covered at least in part by the film or cover 102, preferably in a gas-tight manner.

In particular, the depressions in the support or main body 101 are covered and/or closed by the film or cover 102, and/or the raised portions are formed by the film or cover 102 and/or a (local) bulge of the film or cover 102.

Preferably, the front 100A comprises the film or cover 102 or the front 100A is formed by the film or cover 102.

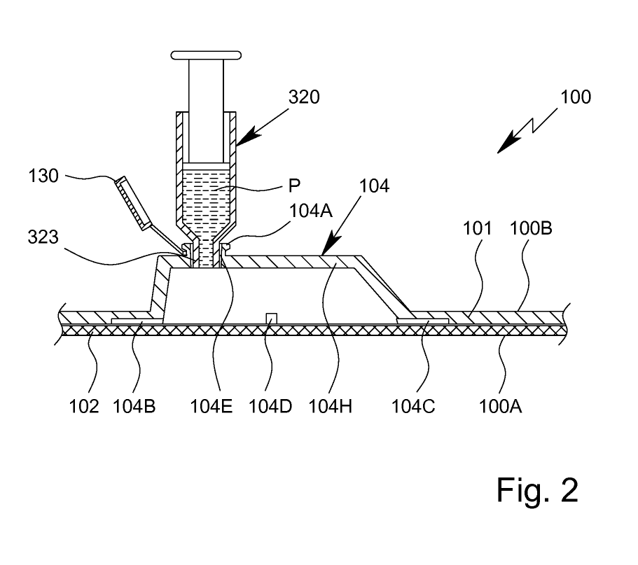

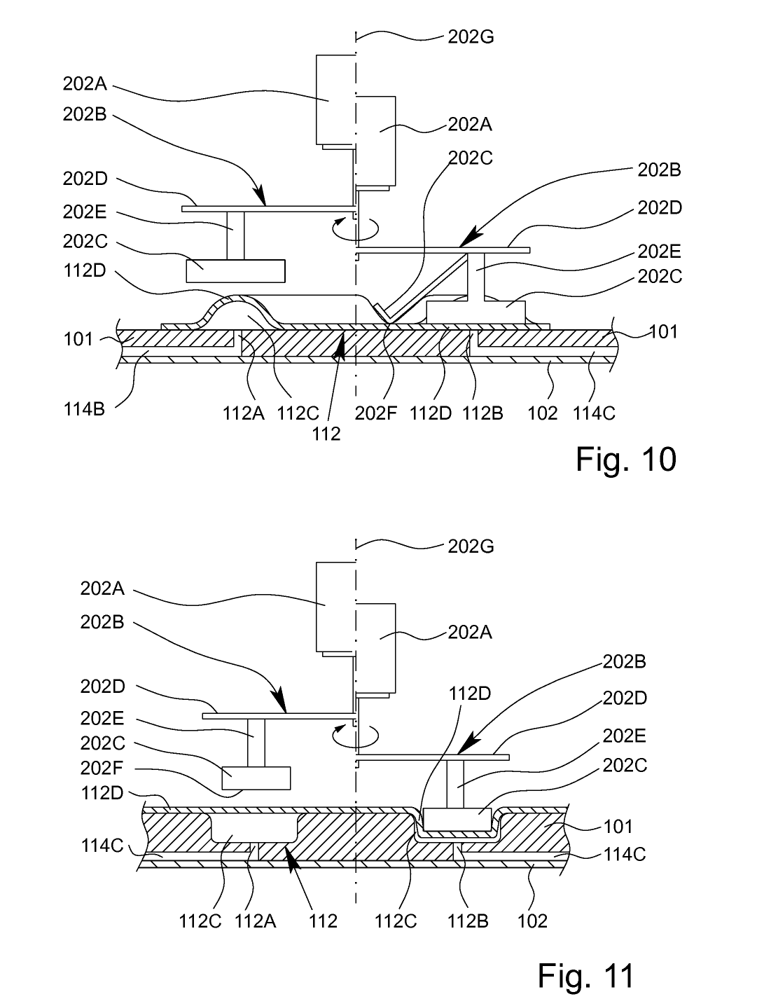

Particularly preferably, the cavities 105, 107 to 109, 111, the channels 114, the valves 115 and/or the pump apparatus 112 and/or the walls thereof are formed by the depressions and/or raised portions in or on the support or main body 101 and by the film or cover 102, as shown schematically in FIG. 2 for the channels 104B, 104C and 104D, and in FIGS. 10 and 11 for the pump apparatus 112. However, other structural solutions are also possible.

FIG. 2 is a highly schematic partial section through the cartridge 100 in the region of the receptacle or receiving cavity 104.

Preferably, the cartridge 100, in particular the support or main body 101, comprises depression 104H, in particular forming the receiving cavity 104, which is covered by the film or cover 102 in this case. Additionally or alternatively, the film or cover 102 forms the receiving cavity 104 and/or depression 104H, preferably so as to be raised from the support or main body 101 or the surface thereof.

The receptacle or receiving cavity 104 preferably comprises a connection 104A for receiving the sample P. In particular, a transfer apparatus 200, in this case preferably comprising a connection 232, in particular a connecting tip , can be connected to the receptacle or receiving cavity 104 or the connection 104A thereof, as shown schematically in FIG. 2, in order to fill the receptacle or receiving cavity 104 with the sample P.

The transfer apparatus 200 may for example be a syringe, a pipette, a tube or the like.

FIG. 2 shows the receptacle or receiving cavity 104 when still empty, i.e. before receiving the sample P.

Once the sample P has been received, the receptacle or receiving cavity 104 can preferably be closed fluidically and in particular also in a gas-tight manner In the example shown, the receptacle or receiving cavity 104 preferably comprises a closure element 130 for this purpose, which in this case is designed in particular as a latched, screwed or hinged lid.

Once the sample P has been received, the transfer apparatus 200 is removed from the receptacle or receiving cavity 104 or the connection 104A and the receptacle or receiving cavity 104 or the connection 104A thereof is closed by the closure element 130.

The fluid system 103 is preferably connected to the receptacle or receiving cavity 104 and/or the depression 104H by means of a connection channel or outlet 104C for receiving and/or discharging the sample P, as shown schematically in FIG. 1 and FIG. 2.

Furthermore, the fluid system 103 is preferably connected to the receptacle or receiving cavity 104 or the depression 104H thereof via a ventilation channel or inlet 104B and/or flushing channel or intermediate connection 104D, such that the sample P or at least a component thereof can be conveyed out of the receptacle or receiving cavity 104 or depression 104H, in particular via the connection channel or outlet 104C, in particular without a (relevant) vacuum developing in the receptacle or receiving cavity 104.

If required, a gas or air can be fed to the receptacle or receiving cavity 104 via the ventilation channel or inlet 104B and/or a liquid, for example a reagent F, can be fed to said receptacle via the flushing channel or intermediate connection 104D, in order to convey the sample P or a component thereof into the fluid system 103, the connection channel or outlet 104C and/or a downstream cavity 105, 107, 109 and/or into the sensor apparatus 113.

The sample P or a component thereof is conveyed out of the receptacle or receiving cavity 104 into the fluid system 103 preferably by suction and/or by overpressure (feeding gas and/or liquid into the receptacle or receiving cavity 104). This is in particular facilitated or made possible by locking, sealing and/or closing the receptacle or receiving cavity 104 and/or the fluid system 103, preferably in a gas-tight manner.

The sample P or a component thereof is particularly preferably conveyed by means of the pump apparatus 112 and/or by accordingly controlling the valves 115 (not shown in FIG. 2).

Preferably, the pump apparatus 112 comprises at least one pump chamber 112C and/or the pump apparatus 112 is formed by at least one pump chamber 112C (in FIG. 1, the pump chamber 112C is indicated by dashed lines).

The pump chamber 112C is preferably designed as a raised portion and/or depression on or in the cartridge 100, in particular the support or main body 101.

Preferably, the pump apparatus 112 and/or the pump chamber 112C comprises a wall 112D that is flexible and/or elastically deformable at least in part, the wall 112D in particular being formed by a film, for example the film or cover 102.

Preferably, the pump apparatus 112 and/or the pump chamber 112C is elastically deformable, in particular compressible, at least in part and/or in portions. In particular, the wall 112D can be pressed onto the support or main body 101 or the surface thereof, the wall 112D or the pump chamber 112C then preferably being reset or enlarged again automatically and/or by a counterforce and/or by a restoring, deflecting or manipulating apparatus 150 (indicated by dashed lines in FIG. 1).

The pump chamber 112C, in particular the wall 112D, is preferably bulged and/or raised relative to the support or main body 101 or the surface thereof and/or is formed as a bead. However, other solutions are also possible here, as explained in greater detail in the following.

Preferably, the pump chamber 112C is curved, in particular is arcuate, in the shape of an arc of a circle or a circle, and/or is formed as an arc or as (part of) a circle, particularly preferably on the support or main body 101, as shown in FIG. 1.

The angle enclosed between the two ends of the pump chamber 112C and/or the angle at the centre is preferably greater than 90°, particularly preferably greater than 120° or 150°, in particular at least substantially 180°, and/or less than 360°, particularly preferably less than 280°, in particular less than 220°.

In an alternative embodiment (not shown), the pump chamber 112C is formed as a ring or is annular, in particular is formed as a toroid, the pump chamber 112C preferably comprising, in particular between an inlet and an outlet, a partition wall for a fluid that is to be conveyed, the partition wall preventing the fluid from circulating within and/or flowing back into the pump chamber 112C and/or from the outlet to the inlet.

The pump chamber 112C preferably has and/or defines a volume, in particular a pump volume, for a fluid, in particular the sample P and/or the reagent F, it preferably being possible for the volume to be changed, in particular to be reduced at least temporarily.

The volume of the pump chamber 112C is preferably greater than 0.05 ml or 0.1 ml, particularly preferably greater than 0.2 ml or 0.5 ml, in particular greater than 1 ml, and/or less than 10 ml, particularly preferably less than 5 ml, in particular less than 2 ml.

Particularly preferably, a fluid, in particular the sample P and/or the reagent F and/or a gas, can be conveyed through the pump chamber 112C, in particular by temporarily changing the pump volume of the pump chamber 112C and/or by deforming, in particular compressing, the pump chamber 112C, the wall 112D and/or the film or cover 102 in portions and/or temporarily.

The pump apparatus 112 or pump chamber 112C preferably comprises an inlet opening or inlet 112A and an outlet opening or outlet 112D and/or is preferably fluidically connected to an inlet channel 114B and an outlet channel 114C, preferably by means of an inlet or inlet opening 112A and an outlet or outlet opening 112D, respectively.

The inlet 112A is preferably arranged on a first end of the pump chamber 112C and the outlet 112D is preferably arranged on a second end thereof. However, other solutions are also possible here.

The conveying direction can preferably be reversed. Depending on the operation of the pump apparatus 5, it is in particular possible for the inlet 112A to be used as the outlet, at least temporarily, and for the outlet 112D to be used as the inlet, at least temporarily.

In the embodiment shown, the cartridge 100 comprises just one pump apparatus 5, the pump apparatus 112 preferably making it possible, depending on the valves 115, to convey the fluid, in particular the sample P and/or the reagent F, through all the cavities 105, 107 to 109 and 111, channels 114 and valves 115. However, other structural solutions are also possible in which the cartridge 100 comprises a plurality of pump apparatuses 112 and/or pump chambers 112C.

Preferably, the pump apparatus 112 and/or pump chamber 112C is designed to make it possible to test the sample P, to convey the sample P, reagents F, other fluids and/or gas, to mix the sample P with reagents, in particular liquid reagents F, and/or to treat the sample P in another way, and/or is designed to control the (dynamic) pressure and/or speed of the fluid, in particular of the sample P and/or the reagent F, through all the cavities 105, 107 to 109 and 111, channels 114 and valves 115.

Once the receptacle or receiving cavity 104 has been closed, the fluid system 103 forms, in particular together with the receptacle or receiving cavity 104 and/or the connected cavities 105, 107 to 109 and 111, channels 114, the pump apparatus 5, pump chamber 112C and/or the sensor apparatus 113, a closed circuit for fluids, in particular gas, air and/or liquids. This is facilitated or made possible by the receptacle or receiving cavity 104 and/or the fluid system 103 being locked, sealed and/or closed, preferably in a gas-tight manner.

The sensor apparatus 113 is designed in particular for electrochemically measuring the prepared sample P. In particular, the sensor apparatus 113 comprises a corresponding biochip or functionalised chip or the like.

The sensor apparatus 113 in particular comprises electrodes 113C that particularly preferably engage in one another in a finger-like manner and/or form a plurality of electrode pairs and/or measurement points. Particularly preferably, the sensor apparatus 113 and/or the chip is constructed as described in U.S. Pat. No. 7,123,029 B2 or U.S. Pat. No. 7,914,655 B2.

The sensor apparatus 113 preferably operates electrically and/or electrochemically. In particular, the cartridge 100 and/or the support or main body 101 comprises electrical contacts 113E for electrically connecting the sensor apparatus 113, as shown schematically in FIG. 1.

As already explained, the cartridge 100 and/or the fluid system 103 preferably comprises one or more sensors or sensor portions 116, in particular for detecting a flow front and/or for detecting the presence of a liquid, for measuring the pH or another value, measuring the temperature or the like.

Preferably, the cartridge 100 and/or the support or main body 101 comprises corresponding electrical contacts 113E and/or 116A for electrically connecting the sensor apparatus 113 and/or sensors or sensor portions 116, just one electrical contact 116A for electrically contacting or connecting an assigned sensor or sensor portion 116 being schematically shown in the view according to FIG. 1 for reasons of simplicity.

As an alternative or in addition to the sensors or sensor portions 116, one or more sensors 206 may also be provided that are in particular used for detecting a flow front and/or for detecting the presence of a liquid, or for measuring the temperature or other values or the like, the sensors 206 preferably not forming part of the cartridge 100, but instead being arranged on or in an assigned analysis device 200, as explained in greater detail in the following.

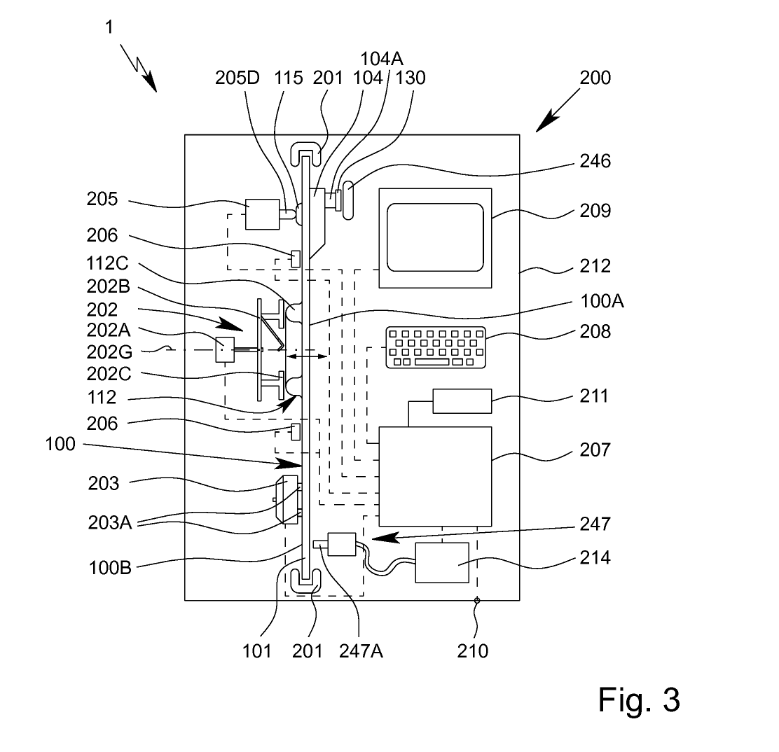

FIG. 3 shows a proposed analysis system or kit 1 comprising the proposed analysis device 200 and the proposed cartridge 100,

Preferably, the analysis device 200 and the assigned cartridge 100 form the proposed analysis system or kit 1 for testing an in particular biological sample P.

The cartridge 100 can preferably be connected to the analysis device 200 and/or can be received by the analysis device 200 at least in part. Particularly preferably, the cartridge 100 can be plugged into the analysis device 200. However, other structural solutions are also possible.

FIG. 3 shows the analysis system 1 in the ready-to-use state for carrying out a test on the sample P received in the cartridge 100. In this state, the cartridge 100 is therefore linked to, received by or plugged into the analysis device 200.

The view in FIG. 3 is merely schematic, in order to illustrate essential functions and/or aspects.

In the example shown, the analysis device 200 preferably comprises a mount or receptacle 201, such as a slot or the like, for receiving and/or mounting the cartridge 100. However, other structural solutions are also possible.

Preferably, the cartridge 100 is fluidically, in particular hydraulically, separated or isolated from the analysis device 200. In particular, the cartridge 100 forms, together with the receptacle or receiving cavity 104, a preferably independent and in particular closed fluidic and/or hydraulic system and/or fluid system 103 for the sample P.

Preferably, the cartridge 100 is electrically and/or pneumatically connected to the analysis device 200. However, in principle or in addition, an optical, mechanical and/or thermal coupling is also possible or provided, in particular for measurement purposes.

The test and/or the test sequence in the cartridge 100 is preferably controlled electrically, thermally, pneumatically and/or mechanically, and/or the effect of the analysis device 200 on the cartridge 100 is preferably electrical, thermal, pneumatic and/or mechanical.

Preferably, the pump apparatus 5, pump chamber 112C and/or valves 115 are actuated mechanically by the analysis device 200.

Particularly preferably, the analysis device 200 only has a mechanical and/or pneumatic effect on the cartridge 100, in particular the pump apparatus 5, pump chamber 112C, valves 115 and/or manipulating apparatus 150, in particular in order to make possible or bring about the desired preparation and/or treatment and testing of the sample P in the cartridge 100 and/or the analysis device 200.

In addition, if required, the analysis device 200 may also have a thermal effect on the cartridge 100 and/or the test sequence and/or the sample P, i.e. for example may temperature-control a treatment or reaction cavity 109 in a desired manner, it also being possible in particular for thermal cycles to be run in order for it to be possible to, for example, carry out a PCR (polymerase chain reaction) in the cartridge 100,

Additionally or alternatively, if required, the cartridge 100 may also comprise a temperature-control or heat-generation apparatus, such as a heating element, thermal element, thermocouple or the like, which can in particular be electrically supplied and/or controlled by the analysis device 200.

The analysis device 200 preferably comprises a pump drive 202 (shown schematically in FIG. 3), the pump drive 202 in particular being designed for mechanically actuating the pump apparatus 112 and/or pump chamber 112C on or in the cartridge 100,

Preferably, the pump apparatus 112 can be driven by means of the pump drive 202, in particular from the outside. In particular, the pump drive 202 is designed to interact with the pump apparatus 112 and/or pump chamber 112C such that the sample P, the reagent F and/or another fluid or gas can be conveyed and/or pumped within the cartridge 100 and/or the analysis device 200.

Preferably, the pump drive 202 is fluidically, in particular hydraulically, separated from the pump apparatus 112 and/or pump chamber 112C, in particular by means of the wall 112D of the pump apparatus 112.

Preferably, the pump drive 202 of the analysis device 200 and the pump apparatus 112 and/or pump chamber 112C of the cartridge 100 together form a pump, in particular a hose pump or peristaltic pump, it preferably being possible for the sample P, the reagent F and/or another fluid to be conveyed, pumped and/or pressurised within the pump apparatus 112 and/or pump chamber 112C by externally mechanically deforming the pump chamber 112C and/or the wall 112D, as already explained at the outset.

For example, the pump may be constructed as described in DE Patent No. 10 2011 015 184 B4 and corresponding U.S. Pat. No. 8,950,424 B2. However, other structural solutions are also possible.

The pump drive 202 preferably comprises an in particular electrical drive and/or motor 202A and a pump head 202B, it preferably being possible for the pump head 202B to be driven by means of the motor 202A, preferably in a rotary or linear manner.

Preferably, the pump head 202B can rotate about an axis of rotation 202G, the axis of rotation 202G preferably being oriented at least substantially orthogonally to the cartridge 100 and/or a main plane of extension of the cartridge 100 and/or support or main body 101, at least during conveying and/or pumping. However, other structural solutions are also possible in which the axis of rotation 202G is oriented at least substantially in parallel with the cartridge 100 and/or a main plane of extension of the cartridge 100,

In an alternative embodiment (not shown), the pump head 202B can preferably be moved linearly and/or in a straight line, in particular such that the pump head 202B moves on the cartridge 100 and/or pump chamber 112C in an at least substantially straight conveying direction. For example, the pump drive 202 can be designed as or comprise a traction mechanism drive, the pump head 202B preferably being formed by the traction mechanism.

Preferably, the cartridge 100 can be moved, in particular displaced, relative to the pump drive 202, in particular the pump head 202B, or vice versa, in particular in order to drive and/or actuate the pump apparatus 5, as shown by a double arrow in FIG. 3.

The pump drive 202 and the pump apparatus 112 can be interconnected and disconnected from one another as desired, preferably by displacing or moving the cartridge 100 relative to the pump drive 202 and/or pump head 202B, or vice versa.

Preferably, the pump drive 202 and/or the pump head 202B is moved away from the cartridge 100, in particular the pump apparatus 112 or pump chamber 112C, in a first position, and is, at least in part, positioned and/or pressed against the cartridge 100, in particular the pump apparatus 112 or pump chamber 112C, in a second position. In FIG. 3, the pump drive 202 is in the first or moved-away position.

In particular, the cartridge 100 can be moved or displaced from the first position, or the position in which it is moved away from the pump head 202B, into the second position, and/or, starting from the first position, can be pressed onto or against the pump head 202B.

Particularly preferably, in the second position the pump drive 202 and/or the pump head 202B is positioned, at least in part, on the cartridge 100, in particular the pump apparatus 112 or pump chamber 112C, and/or in the second position the pump drive 202 and/or the pump head 202B compresses the pump chamber 112C and/or pressure chamber 150B at least in part and/or in portions.

In an alternative embodiment (not shown), the drive and/or motor 202A is designed to move or displace the pump head 202B relative to and/or towards the cartridge 100, in addition to being designed to rotate. In particular, structural solutions are also possible in which the analysis device 200 comprises an additional motor, such as a stepper motor or the like, in order to move the entire pump drive 202 and/or the motor 202A together with the pump head 202B relative to the cartridge 100,

Preferably, at least in the second position, the pump drive 202, in particular the pump head 202B, is operatively connected to the pump chamber 112C on an end face and/or by a side remote from the motor 202A.

The cartridge 100 preferably comprises a plurality of valves 115, as shown in FIG. 1. Preferably, the cartridge 100 comprises more than two or ten, particularly more than 15 or 20, in particular more than 30 or 40, and/or fewer than 100 or 90, particularly preferably fewer than 80 or 70, in particular fewer than 60, valves 115.

The cartridge 100 preferably comprises at least two valve types, in particular a first valve type and a second valve type 152. The first valve type will not be described in further detail in the following.

Preferably, the valve 115 is designed as a membrane valve.

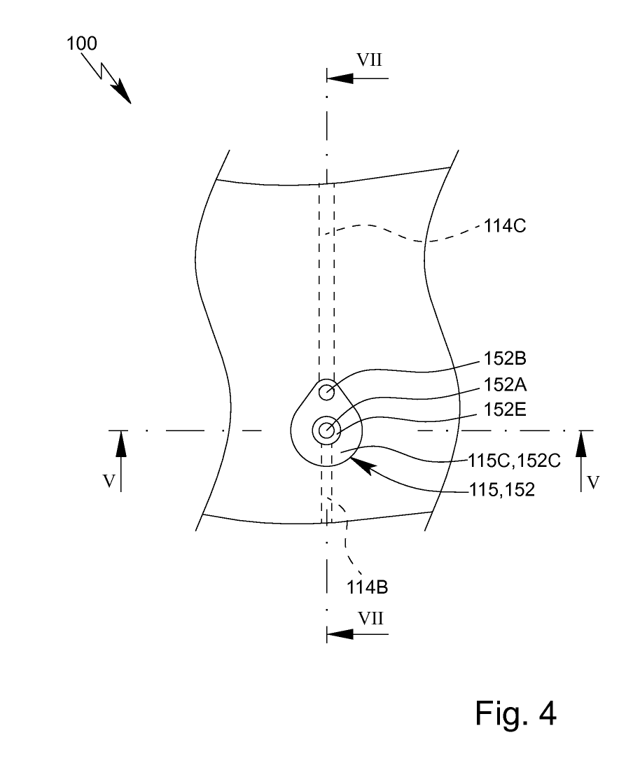

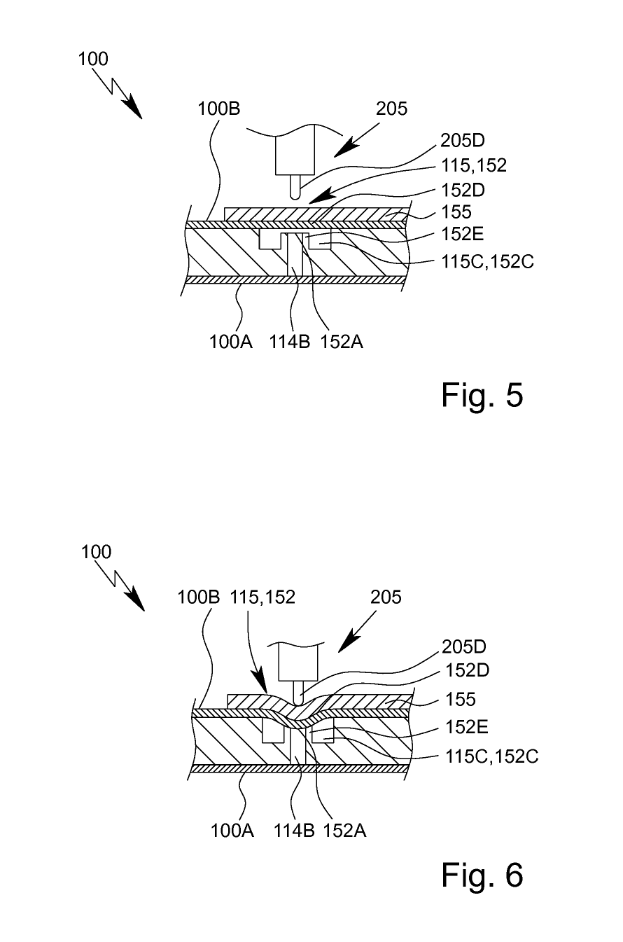

FIG. 5 is a schematic section through the detail of the cartridge 100 along the sectional line V-V (cf. FIG. 4) when unactuated, and FIG. 6 shows said cartridge when actuated.

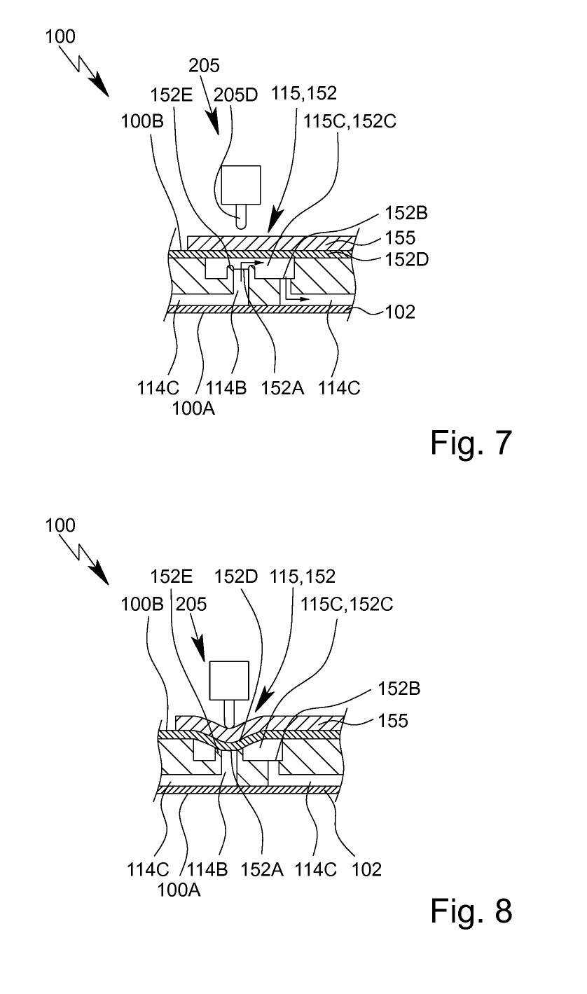

FIG. 7 is a schematic section through the detail of the cartridge 100 along the sectional line VII-VII (cf. FIG. 4) when unactuated, and FIG. 8 shows said cartridge when actuated.

According to the invention, the valves 115 of the cartridge 100 can be actuated, in particular opened and/or closed, from different sides and/or flat sides 100A, 100B of the cartridge 100.

Preferably, at least one valve 115 of the valves 115 can be actuated, in particular opened and/or closed, from the front 100A of the cartridge 100 and at least one other valve 115 of the valves 115 can be actuated, in particular opened and/or closed, from the back 100B of the cartridge 100.

Preferably, some or all of the valves 115 and/or an actuatable film or wall 115D thereof is/are arranged on the back 100B, and/or the film and/or cover 102 is/are arranged on the front 100A of the cartridge 100. In particular, the valves 115 and/or the walls 115D thereof on the one hand and the film or cover 102 on the other hand are arranged on different sides 100A, 100B of the cartridge 100.

The valves 115 are preferably each designed as a raised portion and/or depression on or in the cartridge 100, in particular the support or main body 101.

Preferably, the valves 115 are elastically deformable, in particular compressible and/or expandable, at least in part and/or on one side, preferably in order to actuate said valves.

Preferably, the valves 115 each comprise a wall 115D that is flexible and/or elastically deformable at least in part, the wall 115D in particular being formed by a film, as shown in FIG. 4 to FIG. 8.

Preferably, the wall 115D is arranged on the outside and/or is designed as an in particular continuous layer or film, in particular for some or all of the valves 115, and/or is bonded to the support or main body 101. In particular, the wall 115D is connected, in particular adhered or welded, to the support or main body 101 in a region around the valve 115.

Preferably, the valves 115 can be actuated, in particular opened and/or closed, by elastically deforming the respective walls 115D.

In particular, the wall 115D can be pressed onto or against the support or main body 101 or the surface thereof, or can be pressed into the support or main body 101, preferably in order to close the associated valve 115. This applies in particular to some or all of the valves 115 of the second valve type 152.

Additionally or alternatively, the wall 115D can be pushed away and/or lifted from the support or main body 101 or the surface thereof, in particular in order to open the valve 115. This applies in particular to some or all of the valves of the first valve type.

Preferably, the wall 115D is elastic, resilient and/or flexible such that, once deflected from the unactuated position, and/or once the valve 115 has been actuated and/or once the wall 115D has been deformed, said wall is automatically reset and/or returns to its unactuated position again.

Preferably, the valves 115 each comprise a valve chamber 115C or form such a chamber, the valve chamber 115C preferably being arranged or formed in and/or on the cartridge 100, in particular the support or main body 101.

Preferably, the valve chamber 115C is formed or delimited by the support or main body 101 and the wall 115D.

In particular, the wall 115D covers the valve chamber 115C and/or the wall 115D closes the valve chamber 115C to the outside. This applies in particular to some or all of the valves 115 of the second valve type 152.

Preferably, the wall 115D is connected, preferably bonded, to the support or main body 101, in particular in a non-detachable and/or sealed manner, around the valve chamber 115C.

Preferably, the valve chamber 115C is designed as a raised portion and/or depression on or in the cartridge 100, in particular the support or main body 101, and/or is raised relative to the support or main body 101 or the surface thereof and/or is integrated in said support or surface.

Preferably, when in the operating position, a plurality or all of the valves 115 and/or the valve chambers 115C thereof are oriented, and/or fluid can flow therethrough, vertically and/or from top to bottom, or vice versa.

Preferably, some or all of the valves 115 can be mechanically actuated, in particular opened and/or closed.

Within the meaning of the present invention, the term “actuate” is preferably understood to mean opening and/or closing the valves 115, in particular actively and/or in a controlled or regulated manner, by mechanical action, in particular from the outside and/or by means of (external) actuators and/or actuating apparatuses.

Particularly preferably, the second valve type 152 or the wall 152D thereof is planar or flat, at least when unactuated.

In particular, the second valve type 152 or the wall 152D thereof is integrated in the surface and/or the support or main body 101 of the cartridge 100 such that the second valve type 152, in particular the surface or wall 152D thereof, at least when it is unactuated, and together with the region of the cartridge 100 and/or support or main body 101 directly adjacent to the second valve type 152, is at least substantially flat or planar or is in the same plane.

Preferably, the wall 152D is formed by a film.

Particularly preferably, the wall 152D is made of and/or injection-molded from plastics material, in particular polypropylene.

The thickness of the wall 152D is preferably less than 0.1 mm, in particular less than 0.05 mm, particularly preferably less than 0.01 mm

Preferably, the second valve type 152 can be actuated and/or closed and/or the volume of the valve chamber 152C can be reduced by actuation by means of an (assigned) actuator 205 and/or actuation element 205D.

Preferably, the second valve type 152 or the wall 152D thereof can be pressed into the support or main body 101 for actuation.

Particularly preferably, the wall 152D can be pressed into the valve chamber 152C by actuating the second valve type 152, preferably such that the wall 152D closes the inlet opening 152A and/or the outlet opening 152B.

Preferably, the second valve type 152 is designed as a normally open valve and/or the second valve type 152 is open when unactuated, as shown in FIG. 5 and FIG. 7, preferably such that the sample P, the reagent F and/or another fluid can flow through the second valve type 152.

The second valve type 152 is preferably designed as an automatically opening or self-opening valve. In particular, the second valve type 152 is designed to open automatically, in particular due to restoring forces, following (mechanical) actuation and/or once the actuation is finished or complete.

Preferably, the cartridge 100 comprises an in particular planar cover or layer 155, the cover or layer 155 preferably covering the second valve type 152 and/or the wall 152D, in particular on a side of the wall 152D that is remote from the valve chamber 152C.

Preferably, the cover or layer 155 is connected, particularly preferably adhered, to the wall 152D and/or the support or main body 101 over the entire surface thereof, in particular in a bonded manner

The cover or layer 155 is preferably made of foamed plastics material and/or of, in particular foamed, polyethylene or polyurethane.

Preferably, the cover or layer 155 is elastically deformable and/or is more elastic or resilient than the wall 152D, and/or the cover or layer 155 has a lower (tensile) elastic modulus, preferably in accordance with the English translations of DIN EN ISO 527-1:2012-06, DIN EN ISO 527-2:2012-06 and/or DIN EN ISO 527-3:2003-07, than the wall 152D.

The elastic modulus as defined in chapter 3.9 of the English translation of DIN EN ISO 527-1:2012-06 is the slope of the stress/strain curve of the material in a specified strain interval and is preferably expressed in megapascals (MPa). It may be calculated either as the chord modulus or as the slope of a linear least-squares regression line in the specified strain interval, as described in further detail in chapter 10.3 of the English translation of DIN EN ISO 527-1:2012-06.

The elastic modulus of cover or layer 155 and/or the wall 152D are alternatively or additionally measured or determined as specified in the English translation of DIN EN ISO 527-3:2003-07, in particular when the thickness of the cover or layer 155 and/or the wall 152D is 1 mm or less.

The methods, apparatus and test specimens involved in a measurement or determination of the elastic modulus are detailed in chapters 4 to 9 as well as Annex C of the English translation of DIN EN ISO 527-1:2012-06 and are further detailed in the English translation of DIN EN ISO 527-2:2012-06, in particular in chapter 6.

The elastic modulus of the cover or layer 155 is preferably at least 500 Pa, more preferably at least 1 kPa, more preferably at least 3 kPa, most preferably at least 5 kPa, and/or at most 10 MPa, more preferably at most 1 MPa, more preferably at most 100 kPa, most preferably at most 10 kPa.

The elastic modulus of the wall 152D is preferably more than five times, in particular more than ten times, particularly preferably more than a hundred times, and/or less than a thousand times, in particular less than five hundred times, the elastic modulus of the cover or layer 155.

Preferably, the cover or layer 155 comprises a lower indentation hardness, preferably determined in accordance with Method A of DIN EN ISO 2439:2009-05, and/or a lower compression hardness, preferably determined in accordance with DIN EN ISO 3386-1:2015-10, than the wall 152D.

The indentation hardness is preferably the total force required to produce, under specified conditions, a specified indentation of a standard test piece. Preferably, the indentation hardness is expressed in newtons (N). Particularly preferably, the indentation hardness corresponds to the 40%/30 s indentation hardness index determined by Method A described in the English version of DIN EN ISO 2439:2009-05.

A measurement of the indentation hardness is preferably performed with an apparatus as specified in chapter 5, with a test piece as specified in chapter 6, and according to the procedure specified in chapters 7.1, 7.2 and 7.3 of the English version of DIN EN ISO 2439:2009-05.

The compression hardness mentioned above is preferably the compression stress/strain value CV₄₀ as defined in chapter 3 of the English translation of DIN EN ISO 3386-1:2015-10. This means, the compression hardness is the compression stress/strain characteristic for a compression of 40%, wherein the compression stress/strain characteristic is defined as the stress required to produce a compression, at a constant rate of deformation, during the fourth loading cycle of the test specified in chapters 4 to 6 of the English translation of DIN EN ISO 3386-1:2015-10. The test is performed with an apparatus specified in chapter 4, a test piece specified in chapter 5 and following the procedure specified in chapter 6 of the English translation of DIN EN ISO 3386-1:2015-10.

The compression hardness of the cover or layer 155 is preferably at least 0.5 kPa, more preferably at least 1 kPa, more preferably at least 1.5 kPa, most preferably at least 2 kPa, and/or at most 5.5 kPa, more preferably at most 4.5 kPa, more preferably at most 4 kPa, most preferably at most 3.5 kPa.

The indentation hardness of the cover or layer 155 is preferably at least 20 N, more preferably at least 50 N, more preferably at least 90 N, most preferably at least 120 N, and/or at most 300 N, more preferably at most 250 N, more preferably at most 200 N, most preferably at most 150 N.

The indentation hardness and/or the compression hardness and/or the module of compression of the wall 152D is preferably more than twice, in particular more than five times, particularly preferably more than ten times, the indentation hardness, compression hardness or module of compression, respectively, of the cover or layer 155.

Tests have shown that in particular in this way—that is, through the properties relating to the compressibility, compression hardness and/or indentation hardness—and/or by the cover or layer 155, an even and/or complete sealing of the valve seat 152E is enabled by low force needed for closing the valves 115, which is described further below in more detail.

In particular, the cover or layer 155 causes an even distribution of the force when the valve 115 is actuated, so that an evenly and save closing is achieved also with low closing force and/or actuation force.

Preferably, the cover or layer 155 is thicker than the wall 152D, in particular more than twice or three times as thick. Particularly preferably, the thickness of the cover or layer 155 is more than five times in particular more than eight times, particularly preferably more than ten times, the thickness of the wall 152D.

The thickness of the cover or layer 155 is preferably more than 0.3 mm, in particular more than 0.5 mm, particularly preferably more than 0.7 mm, and/or less than 2.0 mm, in particular less than 1.5 mm, particularly preferably less than 1.2 mm, most preferably approximately 1.0 mm.

Preferably, the cover or layer 155 is designed to reset the wall 152D after said wall 152D has been actuated or deformed, and/or is designed to raise or move said wall 152D away from the valve seat 152E and/or the inlet opening 152A, in particular such that the second valve type 152 and/or the valve chamber 152C is opened again and/or fluid can flow therethrough again.

Particularly preferably, the cover or layer 155 is designed as a reinforcement of the wall 152D and/or is designed to increase the restoring forces of the wall 152D.

Preferably, the cover or layer 155 is designed to compensate for asperities or surface roughness on the cartridge 100, in particular the wall 152D, and/or is designed to reduce the force required for actuating the second valve type 152, in particular by compensating for asperities or surface roughness.

Preferably, the cover or layer 155 is designed to distribute the force acting on the valve when the second valve type 152 is actuated, and/or is designed to deflect the wall 152D evenly and/or in a planar manner, in particular such that even and/or complete sealing of the valve seat 152E and/or the inlet opening 152A is made possible or facilitated.

In particular, when the second valve type 152 is actuated, the cover or layer 155 makes possible or facilitates even and/or complete sealing of the valve seat 152E and/or the inlet opening 152A on the one hand, and makes possible or facilitates resetting of the wall 152D and/or complete opening of the second valve type 152 and/or the inlet opening 152A, on the other hand, once the actuation of the second valve type 152 is finished or complete.

In particular, the cover or layer 155 makes possible or facilitates even or complete sealing of the valve seat 152E and/or the inlet opening 152A with only low actuation force and/or closing force when the valve 115 and/or the second valve type 152 is actuated or closed, respectively.

The wall 115D and the wall 152D preferably comprise the same properties. In particular, the wall 152D and the wall 115D can be formed in one piece and/or identically.

The analysis device 200 preferably comprises further optional components, which will be explained in greater detail in the following.

The analysis device 200 preferably comprises an actuator or an actuation apparatus 205 which has an actuation element 205D used to actuate the assigned valve 115. In particular, the actuation element 205D can act on a flexible wall of the valve 115, such as the film or cover 102 or the like, in order to actuate said valve. However, other structural solutions are also possible.

The analysis device 200 preferably comprises an optional connection apparatus 203 comprising connections or contact elements 203A for electrically connecting the cartridge 100 and/or electrical contacts 113E and/or 116A. In this case, an electrical plug-in connection or another electrical connection or the like, which is preferably automatically established or made when the cartridge 100 is received in the analysis device 200, may also be formed in principle.

The analysis device 200 preferably comprises an optional control apparatus 207 for controlling the sequence of a test and/or for evaluating and/or outputting and/or providing test results.

The analysis device 200 optionally comprises an input apparatus 208, such as a keyboard, a touch screen or the like. Alternatively or additionally, this may be an interface for example for enabling control by means of a smartphone, a laptop, an external keyboard or the like.

The analysis device 200 preferably comprises an optional display apparatus 209, such as a screen. Alternatively or additionally, this may also be an interface, for example for outputting test results to external devices, to a smartphone, a laptop, an external screen or the like.

The analysis device 200 preferably comprises an optional interface 210, for example for outputting test results and/or for connecting to other devices or the like. This may in particular be a wired or wireless interface 210.

For example, a printer may also be connected to the interface 210 in order to output results. Alternatively or additionally, a printer (not shown) may also be integrated in the analysis device 200 or may be formed by the display apparatus 209.

The analysis device 200 preferably comprises an optional power supply apparatus 211, which is in particular integrated or externally connected. This may in particular be a battery or an accumulator and/or power pack or the like.

For mobile use, the analysis device 200 and/or the power supply apparatus 211 may in particular be designed such that it can be directly connected to the on-board power supply of a motor vehicle, i.e. can be operated at 12 or 14 V DC current for example.

The analysis device 200 preferably comprises a housing 212. Particularly preferably, the cartridge 100 can be inserted or slid into the housing 212 through an opening (not shown), such as a slot or the like.

The different apparatuses 207 to 209 and/or 211, the motor 202A and/or the actuator 205 is/are preferably arranged in the housing 212.

The analysis device 200 is preferably portable or mobile.

The analysis device 200 preferably comprises an optional retaining element 246, which is assigned to the receptacle or receiving cavity 104, connection 104A and/or closure element 130 in order to keep the receptacle or receiving cavity 104, the connection 104A thereof and/or the closure element 130 closed and/or to secure them in the closed position when the cartridge 100 is received, as shown merely schematically in FIG. 3.

The analysis device 200 preferably comprises one or more optional sensors 206, in particular for monitoring or controlling the test sequence, as shown schematically in FIG. 3. For example, a liquid front or the presence of liquid in a channel or cavity can be detected, for example optically or capacitively, by means of a sensor 206.

The sensors 206 may be provided in addition to or as an alternative to the sensors or sensor portions 116 arranged on the cartridge 100.

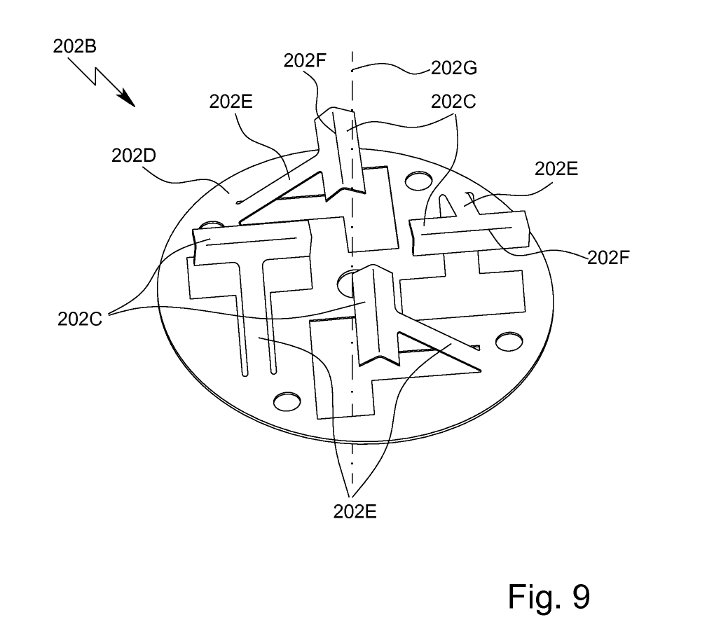

FIG. 9 is a perspective view of the proposed pump head 202B, the construction and mode of operation of which will be explained in greater detail in the following.

The pump head 202B is preferably at least substantially planar and/or disc-like.

Particularly preferably, the pump head 202B comprises a plurality of, in particular at least two, three or four and/or at most eight or ten, contact elements 202C, at least one contact element 202C, particularly preferably several or all of the contact elements 202C, preferably resting on the cartridge 100, pump chamber 112C or wall 112D and/or acting thereon, in particular in the axial direction and/or the direction of rotation, at least in the second position and/or during pumping.

In the second position, the pump head 202B is preferably in direct contact only with the pump chamber 112C and/or wall 112D. In particular, in the second position the pump head 202B is also arranged at a distance from the support or main body 101 and/or only the contact elements 202C that rest on the pump chamber 112C and/or wall 112D are in contact with the cartridge 100. This reduces wear on components that move relative to one another.

Alternatively, in the second position the pump head 202B is in contact with both the pump chamber 112C or wall 112D and the support or main body 101 or regions of the film or cover 102 next to the pump chamber 112C, and/or in the second position all of the contact elements 202C are in contact with the cartridge 100, in particular at least one contact element 202C, preferably several contact elements 202C, resting on the pump chamber 112C or wall 112D, and the other contact element 202C or the other contact elements 202C resting on the support or main body 101 or the region next to the pump chamber 112C.

The pump head 202B preferably comprises a base element 202D, the base element 202D preferably being at least substantially planar and/or disc-shaped and/or extending at least substantially radially relative to the axis of rotation 202G.

Preferably, the pump head 202B, in particular the base element 202D, can be plugged onto the motor 202A and/or is connected to the motor 202A in a form-fitting, interlocking, force-fitting and/or bonded manner In particular, the pump head 202B can be replaced and/or removed from the motor 202A. This makes it possible to perform maintenance on and/or to replace a faulty pump head 202B.

The contact elements 202C preferably project from the base element 202D in the axial direction and/or towards the cartridge 100 and/or the pump chamber 112C.

Particularly preferably, the contact elements 202C are connected to the base element 202D by means of respective connection elements 202E, as shown in particular in FIG. 9.

The pump head 202B is preferably formed in one piece or forms a unit. In particular, the contact elements 202C, the base element 202D and the connection elements 202E are formed in one piece, or the contact elements 202C, the base element 202D and the connection elements 202E form a unit.

The pump head 202B is preferably made of plastics material or metal. In the embodiment shown, the contact elements 202C, together with the respective connection elements 202E, are cut and/or bent out from the base element 202D. However, other solutions are also possible here.

Preferably, the contact elements 202C and/or connection elements 202E can (each) be moved relative to the base element 202D, can (each) be elastically deformed and/or are (each) resiliently connected to the base element 202D.

Preferably, the contact elements 202C can be deflected from an untensioned position into a tensioned position.

Particularly preferably, the pump head 202B and/or the contact elements 202C is/are untensioned in the first position and/or tensioned and/or elastically deformed, in particular pressed axially against the pump head 202B or the base element 202D, in the second position.

In particular, the pump head 202B forms a resilient component, the spring constant of the pump head 202B preferably being less than 10 kN/m, particularly preferably less than 5 kN/m or 1 kN/m, in particular less than 800 N/m or 500 N/m, and/or greater than 1 N/m or 10 N/m, particularly preferably greater than 50 N/m, in particular greater than 100 N/m.

Preferably, the contact elements 202C can each be moved relative to the base element 202D, are each resiliently mounted, can each be deformed elastically and/or biased or pretensioned towards the cartridge 100 or pump apparatus 112, individually and/or independently from one another.

In particular, the contact elements 202C can be deformed elastically and/or biased or pretensioned to different extents. This makes it possible for the pump head 202B to be adapted to and/or positioned against the surface and/or outer contour of the cartridge 100 or pump chamber 112C.

The contact elements 202C are preferably elongate, scoop-like and/or spoon-like.

Particularly preferably, the contact elements 202C are (each) designed as a slider or sliding element and/or are designed so as not to roll and/or are designed to be moved on the cartridge 100 and/or pump apparatus 112 in a sliding and/or non-rolling manner This allows or facilitates a particularly simple construction of the pump head 202B.

The contact elements 202C preferably comprise at least one, preferably two, bevels and/or the contact elements 202C are bevelled in relation to the axis of rotation.

Particularly preferably, the contact elements 202C have a V-shaped or U-shaped cross section. This provides for particularly gentle pumping and/or compression of the pump chamber 112C or wall 112D, and/or prevents or minimises damage, in particular to the flexible wall 112D.

Preferably, the contact elements 202C are designed such that, when in contact with the pump chamber 112C or wall 112D and/or during pumping, they each rest on the pump chamber 112C and/or wall 112D in a line and/or by an in particular radially extending edge or contact edge 202F, and/or such that they act on the pump chamber 112C or wall 112D, and/or such that they each form or comprise a contact edge 202F.

Preferably, the pump drive 202 and/or the pump apparatus 112 is designed to convey and/or pump the sample P, the reagent F and/or another fluid in any direction. In particular, the pump head 202B can be driven, in particular rotated, in two opposing directions. Advantageously, the possible uses of the pump drive 202 are thus increased.

Preferably, the contact elements 202C and/or the connection elements 202E are arranged so as to be offset and/or spaced apart from the axis of rotation 202G and/or arranged on an edge or in an edge region of the base element 202D.

In particular, the contact elements 202C and/or the connection elements 202E are arranged in a circle on the base element 202D and/or in a circle around the axis of rotation 202G.

Preferably, the contact elements 202C or contact edges 202F or the longitudinal extensions thereof are oriented at least substantially in parallel with the base element 202D and/or a main plane of extension of the cartridge 100 and/or orthogonally to the axis of rotation 202G, in particular independently from any movement of the contact elements 202C relative to the base element 202D.

In particular, the contact elements 202C are connected to the base element 202D and/or mounted thereon such that the contact elements 202C are arranged and/or oriented so as to always be at least substantially parallel to the base element 202D and/or such that they remain always at least substantially parallel to the base element 202D, even when said contact elements 202C and/or the connection elements 202E are elastically deformed and/or when there is relative movement between the contact elements 202C and the base element 202D. This provides for particularly efficient pumping by means of the pump drive 202, even when the contact elements 202C are moved relative to the base element 202D.

Preferably, the contact elements 202C are each arranged transversely to the connection elements 202E and/or the contact elements 202C point, in the longitudinal extension thereof, towards the axis of rotation 202G.

Preferably, the connection elements 202E or the respective longitudinal extensions of the connection elements 202E are oriented at least substantially tangentially to a common circle, at least in a plan view of the pump head 202B.

In the embodiments shown, the connection elements 202E are oriented in relation to one another in the manner of a rectangle, at least in a plan view of the pump head 202B. However, other solutions are also possible here.

The connection elements 202E are preferably oriented obliquely to the base element 202D or a main plane of extension of the base element 202D and/or the cartridge 100 or a main plane of extension of the cartridge 100.

Particularly preferably, the angle enclosed in each case between the connection elements 202E or the respective longitudinal axes of the connection elements 202E on the one hand and the base element 202D or a main plane of extension of the base element 202D and/or the cartridge 100 or a main plane of extension of the cartridge 100 on the other hand is greater than 0° or 15°, in particular greater than 20° or 30°, and/or less than 90° or 80°, in particular less than 60° or 50°.

In particular, the contact elements 202C are connected to the base element 202D such that said contact elements 202C can be pivoted relative to the base element 202D and/or moved on an arc of a circle.

FIG. 10 shows the pump or pump arrangement according to a first embodiment.

FIG. 10 shows the pump or pump arrangement both when separated (left-hand side) and when in the operating state or during pumping (right-hand side). On the left-hand side of FIG. 10, the pump drive 202 or pump head 202B is separated or moved away from the cartridge 100, in particular the pump apparatus 112, and is therefore in the first position. Conversely, on the right-hand side of FIG. 10, the cartridge 100 is pressed against the pump drive 202 or pump head 202B and/or the pump head 202B is connected to the cartridge 100, in particular the pump apparatus 112, and/or the pump head 202B is operatively connected to the cartridge 100, and is therefore in the second position.

In the first embodiment shown of the pump, the pump apparatus 112 and/or pump chamber 112C is preferably arranged on the support or main body 101 and/or is raised relative to the support or main body 101.

As shown in FIG. 10, the contact elements 202C are preferably wider than the pump chamber 112C in the radial direction. However, other solutions are also possible, in particular those in which the contact elements 202C are shorter than the pump chamber 112C in the radial direction, as shown in FIG. 11.

The contact elements 202C are preferably designed to cut off, suspend and/or compress the pump chamber 112C and/or to deform the wall 112D in portions, locally and/or at least in part, and/or to press the wall 112D onto the surface of the support or main body 101.

In particular, a volume inside the pump chamber 112C can be enclosed and/or fluidically separated by means of two adjacent contact elements 202C and/or can be moved or conveyed, preferably from the inlet 112A to the outlet 112D or vice versa, by rotating the pump head 202B in the rotational direction.

The pump and/or the pump drive 202 is preferably designed to convey the sample P, the reagent F and/or a gas continuously and/or successively or in intervals. Particularly preferably, metered amounts or volumes of the sample P, the reagent F and/or a gas can be conveyed by means of the pump or pump drive 202.

Preferably, after the wall 112D has been compressed, the sample P, the reagent F and/or another fluid can be drawn into the pump chamber 112C and/or received therein again, preferably from the inlet channel 114B, and by means of the wall 112D being subsequently expanded or reset, in particular automatically and/or locally or in portions, and/or by said wall being pretensioned.

FIG. 11 shows the pump or pump arrangement according to a second embodiment.

FIG. 11 shows the pump or pump arrangement both when separated (left-hand side) and when in the operating state or during pumping (right-hand side). On the left-hand side of FIG. 11, the pump drive 202 or pump head 202B is separated or moved away from the cartridge 100, in particular the pump apparatus 112, and is therefore in the first position. Conversely, on the right-hand side of FIG. 11, the cartridge 100 is moved, displaced or pressed against the pump drive 202 or pump head 202B, and is therefore in the second position.

In the alternative second embodiment of the pump shown in FIG. 11, the pump chamber 112C is preferably integrated in the support or main body 101 and/or is formed as a depression in the support or main body 101. In this embodiment, the wall 112D is preferably arranged so as to be at least substantially planar and/or parallel to the surface of the support or main body 101, at least when the cartridge 100 is in the first position.

Preferably, portions of the wall 112D can be pressed into the depression in the support or main body 101 by the contact elements 202C, as shown on the right-hand side of FIG. 11.

The pump head 202B is in particular designed to be continuously in contact with the cartridge 100, via the elastic and/or resiliently mounted contact elements 202C, during rotational movement, and/or to press the contact elements 202C into the depression in the support or main body 101 during rotational movement.

The respective ends of the pump chamber 112C are optionally bevelled, preferably such that the contact elements 202C can be moved over the pump chamber 112C at least substantially stepless or continuously.

In particular, the wall 112D and/or the depression in the support or main body 101 can each have bevels (not shown) in the rotational direction, which preferably allow the contact elements 202C to be moved or guided over the pump chamber 112C and/or in the depression in the support or main body 101 in an even, stepless, continuous and/or gentle manner.

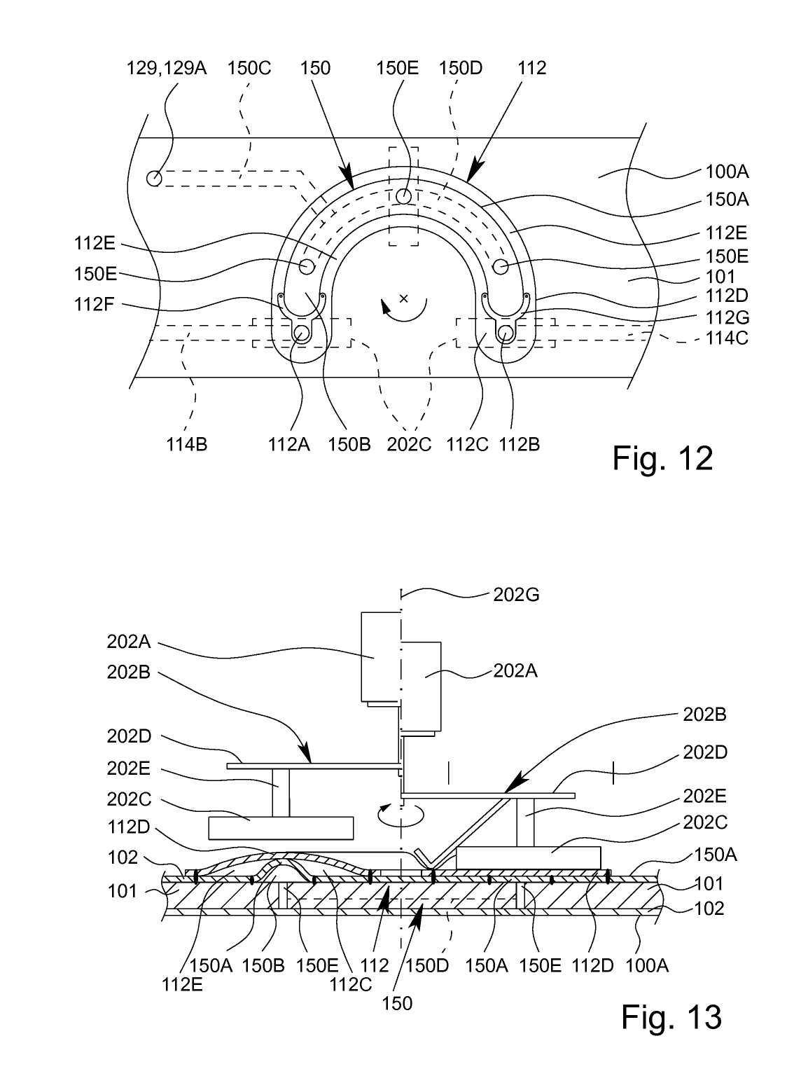

FIG. 12 and FIG. 13 show the pump or pump arrangement according to a third, particularly preferred embodiment, FIG. 12 showing a detail of the back 100B of the cartridge 100 in the region of the pump apparatus 112, and FIG. 13 showing the pump both when separated (on the left-hand side) and when in the operating state or during pumping (right-hand side).

As already mentioned at the outset, the cartridge 100 and/or pump apparatus 112 preferably comprises a manipulating apparatus 150, the manipulating apparatus 150 preferably being designed to enlarge the pump chamber 112C (again) following deformation and/or to raise the wall 112D and/or push said wall 112D away from the support or main body 101.

Preferably, a working medium, in particular gas, air or a liquid, is or can be admitted to the manipulating apparatus 150 and/or the manipulating apparatus 150 is or can be driven by the working medium.

Particularly preferably, the manipulating apparatus 150 is designed as a pneumatic or hydraulic counter bearing, in particular an air cushion, for the pump, in particular the pump drive 202 and/or pump head 202B, as explained in greater detail in the following.

The manipulating apparatus 150 is preferably arranged below the pump apparatus 112 or pump chamber 112C and/or between the pump apparatus 112 or pump chamber 112C and the support or main body 101 in a plan view of the cartridge 100, as shown in FIG. 12.

The cartridge 100 and/or manipulating apparatus 150 preferably comprises a manipulating or deflecting element 150A, it preferably being possible for the pump chamber 112C to be enlarged by means of the manipulating element 150A and/or for the wall 112D to be raised by means of the manipulating element 150A. In FIG. 1, the manipulating element 150A is indicated by dashed lines.

The manipulating apparatus 150 preferably comprises a pressure chamber 150B, or a pressure chamber 150B can be formed, in particular on or in the support or main body 101, by means of the manipulating apparatus 150 or the manipulating element 150A. Particularly preferably, the manipulating element 150A is designed as a wall or part of the wall of the pressure chamber 150B.

Particularly preferably, the working medium can be admitted to the manipulating apparatus 150 such that the manipulating element 150A is elastically deformed, is raised relative to the support or main body 101 and/or forms the pressure chamber 150B.

In particular, the manipulating apparatus 150, manipulating element 150A and/or the pressure chamber 150B can be elastically deformed, in particular compressed, at least in part and/or in portions, particularly preferably in the same manner as and/or together with the pump apparatus 112, pump chamber 112C and/or wall 112D.

More particularly preferably, the manipulating element 150A can be pressed onto the support or main body 101 or the surface thereof together with the wall 112D, in particular by means of the pump and/or pump head 202B.

The pressure chamber 150B, in particular the manipulating element 150A, is preferably bulged and/or raised relative to the support or main body 101 or the surface thereof and/or is formed as a bead, at least when deflected, as shown on the left-hand side of FIG. 13. However, other solutions are also possible here.

Preferably, the pressure chamber 150B is curved, in particular is arcuate or in the shape of an arc of a circle, and/or is formed as an arc or as (part of) a circle, particularly preferably on the support or main body 101, as shown in FIG. 1 and FIG. 12.

The manipulating element 150A is preferably formed by a preferably flexible and/or elastically deformable layer, cover or film.

The manipulating element 150A is preferably bonded to the support or main body 101, in particular by adhesion and/or welding.

The pressure chamber 150B is preferably separated from the pump chamber 112C by means of the manipulating element 150A.

Particularly preferably, the manipulating element 150A comprises a preferably peripheral weld seam, preferably such that the manipulating element 150A fluidically separates the pressure chamber 150B from the pump chamber 112C.

The volume of the pump chamber 112C when deflected is preferably greater than the volume of the pressure chamber 150B.

Particularly preferably, the pressure chamber 150B and/or the manipulating element 150A, in particular the entirety thereof, is arranged inside and/or below the pump chamber 112C and/or the wall 112D.

In particular, the pressure chamber 150B and/or the manipulating element 150A is covered, preferably completely and/or in the manner of a dome, by the pump chamber 112C and/or the wall 112D on the outside of the pressure chamber 150B and/or manipulating element 150A and/or on a side remote from the support or main body 101.

Particularly preferably, a pump channel 112E can be formed in the pump chamber 112C by means of the manipulating element 150A, as shown on the left-hand side of FIG. 13.

At least when the pump chamber 112C or wall 112D is deflected, the pump channel 112E is preferably arranged between the wall 112D, the manipulating element 150A and the support or main body 101 and/or is preferably delimited or defined by the wall 112D, the support or main body 101 and the manipulating element 150A.

The pump channel 112E preferably connects the inlet 112A to the outlet 112D and/or the inlet channel 114B to the outlet channel 114C.

At least when the pump chamber 112C or wall 112D is deflected, the pump channel 112E is preferably formed on both sides of the manipulating apparatus 150 or manipulating element 150A and/or a first or outer pump channel 112E and a second or inner pump channel 112E can preferably be formed by means of the manipulating element 150A, the outer pump channel 112E preferably being longer than the inner pump channel 112E and/or being positioned, starting from the centre or central point of the pump apparatus 112, on a larger radius than the inner pump channel 112E.

The pump apparatus 112 preferably comprises a distribution channel 112F, the distribution channel 112F preferably being designed to distribute the fluid to be conveyed in the pump chamber 112C and/or in the pump channel 112E, in particular in an at least substantially even manner between the outer pump channel 112E and the inner pump channel 112E.

Preferably, the distribution channel 112F fluidically connects the inlet 112A and/or inlet channel 114B to the pump chamber 112C, in particular the pump channel 112E.

The distribution channel 112F is preferably forked, in particular at an end of the manipulating element 150A or pressure chamber 150B that faces the inlet 112A, as shown in particular in FIG. 12.

The pump apparatus 112 preferably comprises a collection channel 112G, the collection channel 112G preferably being designed to collect the fluid in the pump chamber 112C and/or in the pump channel 112E and/or from the outer pump channel 112E and the inner pump channel 112E, and/or to feed said fluid to the outlet 112D and/or outlet channel 114C in a collected manner.

The collection channel 112G is preferably forked, in particular at an end of the manipulating element 150A or pressure chamber 150B that faces the outlet 112D.

The distribution channel 112F and the collection channel 112G are preferably each formed as a depression in the support or main body 101.

The cartridge 100 and/or the manipulating apparatus 150 preferably comprises an in particular pneumatic connection 129, the cartridge 100 and/or the manipulating apparatus 150 preferably being able to be supplied with the working medium by means of the connection 129.

The connection 129 is preferably formed as an opening or hole in the support or main body 101, as shown in FIG. 1 and FIG. 12.

The connection 129 preferably comprises a connection opening 129A, the connection opening 129A preferably being arranged on the back 100B of the cartridge 100 and/or being integrated in the surface of the support or main body 101. However, other solutions are also possible here.

The manipulating apparatus 150 preferably comprises a connection channel 150C, the connection channel 150C in particular fluidically connecting the connection 129 to the pressure chamber 150B.

The manipulating apparatus 150 preferably comprises a distribution channel 150D and at least one feed channel 150E, it preferably being possible for the working medium to be fed from the distribution channel 150D to the pressure chamber 150B via the feed channel 150E.

Particularly preferably, the connection channel 150C connects the distribution channel 150D to the connection 129 and/or the feed channel 150E connects the distribution channel 150D to the pressure chamber 150B.

Preferably, some or all of the channels 114 of the cartridge 100, in particular the connection channel at the outlet 104C, the ventilation channel at the inlet 104B, the flushing channel at the intermediate connection 104D, the inlet channel 114B, the outlet channel 114C, the connection channel 150C and/or the distribution channel 150D, are arranged in a common plane and/or in the main plane of extension of the cartridge 100.

Preferably, the feed channel 150E is arranged at least substantially orthogonally to the main plane of extension of the cartridge 100 and/or to the distribution channel 150D and/or connection channel 150C, and/or the feed channel 150E extends from the front 100A of the cartridge 100 to the back 100B thereof, or vice versa.

In a plan view of the cartridge 100 or the front 100A of the cartridge 100, as shown in FIG. 1, the distribution channel 150D is preferably arranged directly above the pressure chamber 150B, the manipulating element 150A and/or the pump chamber 112C.

The manipulating apparatus 150 preferably comprises a plurality of, in this case three, feed channels 150E, the feed channels 150E in particular being distributed across the distribution channel 150D and/or the pressure chamber 150B, preferably in an at least substantially even or equidistant manner.

Preferably, one feed channel 150E discharges into the pressure chamber 150B at each end or end region of said chamber.

Preferably, one feed channel 150E discharges into the pressure chamber 150B at the centre thereof or discharges centrally into the pressure chamber 150B.

Preferably, at least one valve 115 (not shown in FIG. 5 to FIG. 8) is assigned to the pump apparatus 112 and/or arranged in front of, behind or in the pump apparatus 112.

Preferably, one valve 115 is provided at the inlet 112A and/or at the outlet 112D of the pump apparatus 112, in particular in order to control the flow of fluid through the pump chamber 112C and/or to prevent fluid from flowing back out of the pump chamber 112C or in the direction opposite the conveying direction.

The fluidic, in particular pneumatic, coupling between the cartridge 100 and the analysis device 200 will be explained in greater detail in the following, it being possible for the following aspects to be implemented independently from the preceding aspects.

As already explained, the analysis device 200 is or can be linked to the cartridge 100, the manipulating apparatus 150 and/or the connection 129 preferably fluidically, in particular pneumatically or hydraulically.

Particularly preferably, the analysis device 200 is designed to supply the cartridge 100, the manipulating apparatus 150 and/or the pressure chamber 150B with the working medium, in particular gas or air.

Preferably, the working medium can be compressed and/or pressurised in the analysis device 200 or by means of the analysis device 200.

Preferably, the analysis system 1 or analysis device 200 comprises a pressurised gas supply 214 (shown only in FIG. 3), in particular a pressure generator or compressor, in particular in order to compress, condense and/or pressurise the working medium.

The pressurised gas supply 214 is preferably integrated in the analysis device 200 or the housing 212.

The pressurised gas supply 214 is preferably electrically operated or can be operated by electrical power. In particular, the pressurised gas supply 214 can be supplied with electrical power by means of the electrical connection apparatus 203.

The analysis device 200, in particular the pressurised gas supply 214, is preferably designed to compress the working medium to a pressure of more than 100 kPa, particularly preferably more than 150 kPa or 200 kPa, in particular more than 300 kPa or 350 kPa, and/or of less than 1 MPa, particularly preferably less than 900 kPa or 800 kPa, in particular less than 700 kPa, and/or to feed said medium to the manipulating apparatus 150 at said pressure.

Particularly preferably, the pressure in the pressure chamber 150B, when said chamber is loaded, is more than 100 kPa, particularly preferably more than 150 kPa or 200 kPa, in particular more than 300 kPa or 350 kPa, and/or less than 1 MPa, particularly preferably less than 900 kPa or 800 kPa, in particular less than 700 kPa.

Preferably, air can be drawn in, in particular from the surroundings, as the working medium by means of the analysis device 200 or pressurised gas supply 214.

Preferably, the analysis device 200 and/or pressurised gas supply 214 comprises an open circuit and/or the pressurised gas supply 214 is integrated in an open circuit for the working medium. However, other solutions are also possible here, in particular those in which the analysis device 200 or pressurised gas supply 214 comprises or forms a closed circuit and/or the pressurised gas supply 214 is integrated in a closed circuit for the working medium.

Preferably, the analysis device 200 and/or pressurised gas supply 214 is designed to use the surroundings as a reservoir for the working medium or the air. However, other solutions are also possible here, in particular those in which the analysis device 200 or pressurised gas supply 214 comprises a preferably closed or delimited reservoir, such as a tank or container, for the working medium, and/or is connected or connectable thereto (not shown).

Preferably, the analysis device 200 and/or pressurised gas supply 214 comprises an inlet, the working medium, in particular air, in particular being able to be drawn in and/or conducted to the pressurised gas supply 214 via the inlet.

Preferably, the analysis device 200 and/or pressurised gas supply 214 comprises a filter, it preferably being possible to filter the working medium by means of the filter and/or it preferably being possible for particles to be separated from the working medium.

The filter is preferably designed as a micro filter or as a fine particulate air filter. Preferably, particles having a particle diameter of 10 μm, particularly preferably 8 μm or 9 μm, in particular 6 μm or 7 μm, more particularly preferably 4 μm or 5 μm, can be separated by means of the filter, the particle diameter preferably being the maximum or average diameter of the respective particles. This ensures that the channels or lines that convey the working medium, in particular the connection 129, the connection channel 150C, the distribution channel 150D, the feed channel 150E and/or the pressure chamber 150B, do not become contaminated or clogged or that no undesired pressure loss occurs.

The analysis system 1 or analysis device 200 preferably comprises a connection apparatus 247, preferably in order to fluidically, in particular pneumatically, connect the analysis device 200, in particular the pressurised gas supply 214, to the cartridge 100, the manipulating apparatus 150 and/or the connection 129.

The pressurised gas supply 214 can preferably be connected, particularly preferably fluidically, in particular pneumatically, to the cartridge 100 and/or manipulating apparatus 150 by means of the connection apparatus 247.

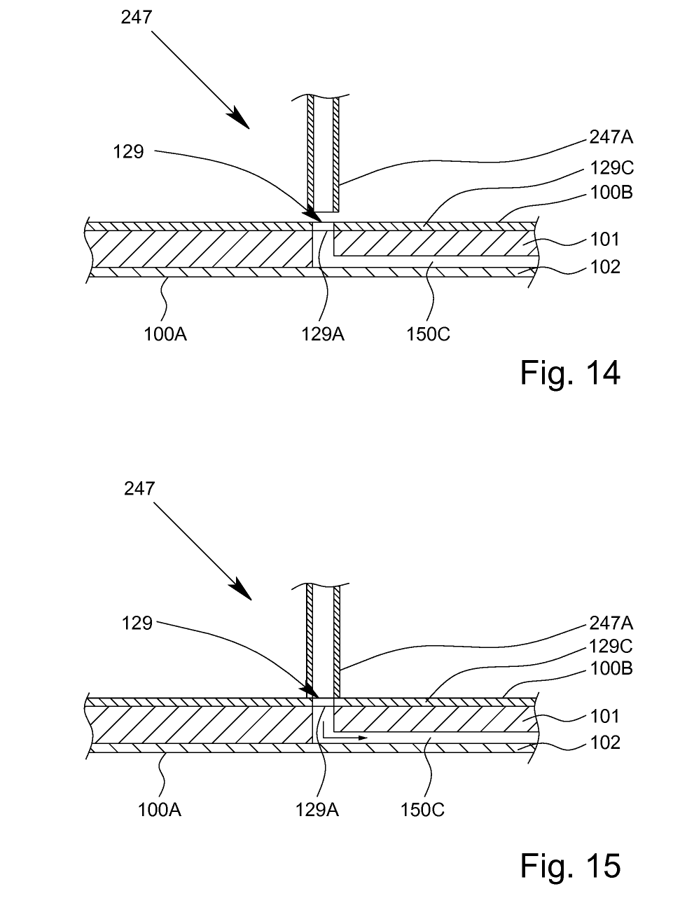

FIG. 14 is a schematic section through the cartridge 100 in the region of the connection 129, together with the connection apparatus 247 of which a detail is shown and which is moved away from the cartridge 100.

FIG. 15 is a schematic section through the cartridge 100 in the region of the connection 129, together with the connection apparatus 247 in the pressed against and/or coupled state of the cartridge 100.

The connection apparatus 247 preferably comprises at least one connection element 247A.

In particular, the connection apparatus 247 is designed to connect the analysis device 200, in particular the pressurised gas supply 214, to the cartridge 100, in particular the connection 129, in a sealing and/or fluidic, in particular pneumatic, manner.

Particularly preferably, the connection apparatus 247 and/or the connection element 247A can be positioned against the cartridge 100 and/or the connection 129 and/or coupled to the cartridge 100 and/or the connection 129 in a sealing manner.

Preferably, the cartridge 100, in particular the connection 129, and/or the connection apparatus 247 comprises a seal 129C, the seal 129C preferably being able to establish a preferably gas-tight connection between the analysis device 200, in particular the connection apparatus 247, and the cartridge 100, in particular the manipulating apparatus 150.

The seal 129C can be made of the same material as the cover or layer 155 and/or can be formed in one piece with the cover or layer 155. Preferably thus, some or all features of the cover or layer 155 also apply to the seal 129C.

In particular, the connection apparatus 247 and/or the connection element 247A can be sealingly connected to the cartridge 100, the connection 129 and/or the connection opening 129A by means of the seal 129C, in particular such that the working medium can be fed from the analysis device 200 to the cartridge 100 and/or to the manipulating apparatus 150.

The seal 129C is preferably arranged in the region of the connection opening 129A, in particular is formed around the connection opening 129A.

The seal 129C is preferably planar and/or is formed as a film, layer or cover. Particularly preferably, the seal 129C has a sealing surface area of greater than 1 mm² or 4 mm², in particular greater than 9 mm² or 25 mm², and/or of less than 200 cm² or 180 cm², in particular less than 150 cm² or 120 cm², the sealing surface area of the seal 129C preferably being the surface area of a side of the seal 129C that faces the connection apparatus 247 and/or is remote from the support or main body 101.

Preferably, the seal 129C is arranged on or attached to the support or main body 101, in particular the back 100B of the cartridge 100, and/or is thus directly or indirectly connected to the support or main body 101 or the film, wall 112D or cover 102 optionally arranged therebetween, preferably in a bonded manner, in particular by adhesion, and/or over the entire surface thereof, as shown in FIG. 8.

Particularly preferably, the seal 129C is assigned to the cartridge 100 and/or the cartridge 100 comprises or forms the seal 129C, preferably on the back 100B and/or on a side facing the connection apparatus 247 and/or the connection element 247A. Advantageously, each new cartridge 100 thus also provides a new seal 129C and/or the cartridge 100 can be disposed of together with the seal 129C. This is conducive to hygienic testing of the sample P. However, other solutions are also possible here, in particular those in which the connection apparatus 247 and/or connection element 247A comprises or forms the seal 129C, preferably on a side facing the cartridge 100.

The seal 129C is preferably made of and/or injection-moulded from in particular foamed plastics material and/or in particular foamed polyurethane or polyethylene.

Preferably, the seal 129C is elastically deformable and/or is more elastic or resilient than the support or main body 101, the film or cover 102 and/or the manipulating element 150A.

Preferably, the cartridge 100 can be moved, in particular displaced, relative to the connection apparatus 247, in particular the connection element 247A, or vice versa, in particular in order to connect the analysis device 200 to the cartridge 100 fluidically, in particular pneumatically.

The cartridge 100, in particular the manipulating apparatus 150, and the analysis device 200, in particular the connection apparatus 247, can be connected to, coupled to and separated from one another, fluidically or pneumatically as desired, preferably by moving the cartridge 100 relative to the connection apparatus 247 or connection element 247A, or vice versa.

Preferably, the cartridge 100 is moved away from the connection element 247A in a first position, as shown in FIG. 14, and is positioned and/or pressed against the connection element 247A in a second position, as shown in FIG. 15.

The connection element 247A is preferably cylindrical, tubular and/or dome-like. In a particularly preferred embodiment (not shown), the connection element 247A is designed as a hollow needle.

Particularly preferably, the connection element 247A can be pressed onto the connection 129 and/or the seal 129C, preferably such that the connection element 247A and the connection 129 are interconnected or coupled together fluidically, preferably in a gas-tight manner.

Particularly preferably, the connection element 247A, in particular the end face thereof, is positioned on or rests on the cartridge 100, in particular the connection 129 and/or the seal 129C, in the second position.

Preferably, the connection element 247A can be positioned so as to be at least substantially coaxial with the connection 129 and/or the connection opening 129A thereof.

Preferably, the internal cross-sectional area and/or external cross-sectional area of the connection element 247A is greater than the internal cross-sectional area of the connection 129 and/or the cross-sectional area of the connection opening 129A.

In particular, the end face of the connection element 247A can be connected to the cartridge 100, the support or main body 101 and/or the seal 129C in a region around the connection 129 and/or the connection opening 129A. Structural solutions are in particular possible in which the connection 129 can be plugged into the connection element 247A.

Alternatively, the connection element 247A can be plugged into the connection 129 and/or the connection opening 129A at least in part.

In another embodiment (not shown), the connection element 247A and/or the connection 129 and/or the connection opening 129A is/are conical, preferably such that the connection element 247A and the connection 129 centre one another (not shown). In this way, any manufacturing tolerances can be compensated.

In another embodiment (not shown), preferably prior to the first use of the cartridge 100, the connection 129 and/or the connection opening 129A is closed or sealed, and/or the cartridge 100 can comprise a sealing means, such as a film, the sealing means and/or the seal 129C preferably covering and/or sealing the connection 129 and/or the connection opening 129A.

In an embodiment of this kind, in particular for a first use, the seal 129C and/or the sealing means can preferably be severed, pierced, broken and/or destroyed by means of the connection element 247A in order to produce a fluidic connection between the analysis device 200 and the cartridge 100, and/or the connection element 247A can be pushed through the seal 129C and/or the sealing means and into the connection 129 and/or the connection opening 129A. This ensures that the cartridge 100, in particular the connection 129, is not contaminated prior to the first use.

In the following, a preferred sequence of a test using the proposed cartridge 100 and/or the proposed analysis device 200 and/or analysis system 1 and/or in accordance with the proposed method is explained in greater detail.

Preferably, a test is carried out on site, i.e. independently from a central laboratory or the like, for example by a veterinarian or another doctor. Preferably, the present invention is thus used as a point-of-care system.

A sample P is preferably received by the receptacle or receiving cavity 104 of the cartridge 100. For this purpose, the receptacle or receiving cavity 104 or the closure element 130 thereof is preferably first opened. The sample P is then preferably manually introduced or inserted into the receptacle or receiving cavity 104 or placed therein, in particular by means of the transfer apparatus 320.

Once the sample P has been received, the receptacle or receiving cavity 104 or the connection 104A thereof, as well as the vent 104E, if provided, are fluidically closed by the closure element 130, in particular in a liquid-tight and gas-tight manner

The cartridge 100 is (then) preferably connected to the analysis device 200, in particular is inserted or slid into said analysis device.

Preferably, the analysis device 200, in particular the pressurised gas supply 214 and/or the connection apparatus 247, is connected to the cartridge 100 fluidically, in particular pneumatically, once the cartridge 100 has been received.

Particularly preferably, the cartridge 100 is moved relative to the connection element 247A and/or towards the connection element 247A and/or pressed onto the connection element 247A, or vice versa, preferably in order to connect the analysis device 200 and/or pressurised gas supply 214 to the cartridge 100 and/or manipulating apparatus 150.

Preferably, the connection element 247A is positioned on the connection 129 or plugged into the connection 129 and/or the connection opening 129A thereof.

Preferably, the working medium is taken from the surroundings and/or drawn in from the surroundings, in particular by means of the analysis device 200 or pressurised gas supply 214.

The working medium is optionally filtered, preferably by means of a filter.

Preferably, the working medium, in particular air, is compressed and/or pressurised by means of the analysis device 200, in particular the pressurised gas supply 214.

Preferably, the compressed and/or pressurised working medium is fed to the cartridge 100 and/or manipulating apparatus 150, preferably via the connection apparatus 247 and/or the connection 129.

The manipulating element 150A is preferably raised and/or expanded by the working medium. Particularly preferably, the volume of the pressure chamber 150B is enlarged and/or the pressure chamber 150B is inflated.

Preferably, the manipulating element 150A is pressed onto the wall 112D of the pump chamber 112C by the working medium and/or the wall 112D is pressurised, raised and/or expanded by means of the manipulating element 150A.

Preferably, the cartridge 100 is simultaneously, previously or subsequently moved relative to the pump head 202B, or vice versa, in particular such that all the contact elements 202C rest on the cartridge 100 and/or at least one contact element 202C, preferably several or all of the contact elements 202C, rests/rest on the pump chamber 112C and/or wall 112D.

In particular, the cartridge 100 is moved far enough that the pump head 202B, in particular some or all of the contact elements 202C and/or connection elements 202E, is/are elastically deformed, and/or, at least in part, adapted to and/or pressed onto the surface of the cartridge 100 and/or the pump chamber 112C.

The pump is then activated or the pump head 202B is driven or rotated, in particular in order to start the test or analysis of the sample P.

During pumping, the contact elements 202C are preferably moved on or over the pump chamber 112C and/or pressure chamber 150B in a sliding manner, the contact elements 202C preferably elastically deforming, in particular pushing in or compressing, the pump chamber 112C, wall 112D and/or the manipulating element 150A at least in portions.

The contact elements 202C are preferably resiliently mounted such that any asperities or surface roughness on the cartridge 100 can be compensated for at least in part by said contact elements 202C during rotation.

Particularly preferably, the contact elements 202C are moved on the cartridge 100 under tension, preferably such that said elements always exert a contact pressure on the cartridge 100 and/or pump chamber 112C and/or wall 112D.

The sample P, the reagent F and/or another fluid is/are preferably conveyed from the inlet 112A to the outlet 112D, or vice versa, by the action of the pump head 202B and/or the contact elements 202C.

Preferably, both the wall 112D and the manipulating element 150A are elastically deformed and/or pressed onto the support or main body 101 in portions, preferably by means of the contact elements 202C, in order to convey the sample P and/or fluid.

Preferably, only the portion or region of the wall 112D that is in contact with a contact element 202C is deformed and/or compressed.

Preferably, the portion or region of the wall 112D in front of, behind and/or around the deformed portion or region of the wall 112D is raised by means of the manipulating element 150A.

The sample P in the cartridge 100 is then tested in the analysis device 200, preferably at least largely in an automated manner or automatically.

The sample P is removed from the receptacle or receiving cavity 104 or depression 104H at least in part, in this case via the connecting channel or outlet 104C.

In order to cause said sample to be removed and/or to prevent negative pressure from building up in the receptacle or receiving cavity 104, a fluid, in particular air or another gas or a liquid, such as a flushing liquid or the like, is fed to the receptacle or receiving cavity 104, in particular via the ventilation channel or inlet 104B and/or flushing channel or intermediate connection 104D, preferably by means of the pump, the pump apparatus 112 and/or the pump drive 202.

In order to convey the sample P out of the receptacle or receiving cavity 104, the pump or pump apparatus 112 can generate negative pressure on the outlet side and/or overpressure in the receptacle or receiving cavity 104 on the inlet side, in particular via the ventilation channel or inlet 104B and/or via the flushing channel or intermediate connection 104D. Here, if required, the relatively large collection cavity 111 can be used as a pressure storage means for applying pressure to the receptacle or receiving cavity 104 and/or for equalising the pressure.

The sample P is treated, prepared and/or metered and/or added to or mixed with reagents, in particular liquid reagents F, in the desired or required manner in the cartridge 100.

For example, the sample P is first fed to the measuring or metering cavity 105 for metering, preferably by means of the pump, the pump apparatus 112 and/or the pump drive 202.

The sample P is then preferably fed to a mixing cavity 107 and mixed with a reagent or a plurality of reagents, in particular a liquid reagent F or a plurality of liquid reagents F, for example in order to dilute the sample P, to adjust the pH, to lyse cells and/or to carry out other reactions, preferably by means of the pump, the pump apparatus 112 and/or the pump drive 202.

The reagents may also be provided or introduced as dry reagents if required.

The sample P is then preferably fed to at least one treatment or reaction cavity 109, for example in order for a PCR or other treatment to be carried out therein, preferably by means of the pump, the pump apparatus 112 and/or the pump drive 202. Here too, corresponding reagents, in particular liquid reagents F, may again be added or mixed in if required.

The PCR or other treatment may take place or be carried out at specified temperatures. The cartridge 100, the analysis device 200 and/or the proposed analysis system 1 is preferably designed such that the desired temperatures or temperature profiles for the sample P are achieved, maintained or passed through in the respective cavities and channels. In particular, corresponding temperature control or regulation is provided or implemented.

The method sequence, in particular the flow and conveying of the liquids, the mixing and the like, is/are controlled by the analysis device 200 and/or the control apparatus 207, in particular by accordingly activating or actuating the pump drive 202 or pump apparatus 112 and the valves 115.

The analysis device 200 and/or the control apparatus 207 thereof can detect liquid states, for example a liquid front or the presence of liquid, in particular by means of the sensors or sensor portions 116 and/or sensors 206, and can accordingly take this into account for the control.

Additionally or alternatively, also optical detection or measurement can be carried out, for example for the presence of liquid, the fill level of a cavity or the like.

The collection cavity 111 is used in particular to receive excess or used liquids, such as the sample P, reagents F or the like. Alternatively or additionally, the collection cavity 111 is optionally also used for pressure equalisation, since, after the receptacle or receiving cavity 104 has been closed, a fluidically completely closed circuit is preferably formed on or in the cartridge 100.

The collection cavity 111 preferably comprises a flexible or elastically deformable wall, which is in particular formed by the film or cover 102 or the like, in particular in order to make the above-mentioned pressure equalisation possible. However, other structural solutions are also possible.

The prepared sample P or components thereof, for example amplified DNA sequences, is/are lastly fed to the sensor apparatus 113, preferably by means of the pump, the pump apparatus 112 and/or the pump drive 202.

Preferably, the sample P is then in particular electrochemically measured, for example for the presence of at least one desired target analyte.

The preferably electrical measurement is controlled by the analysis device 200 or the control apparatus 207 and/or the sensor apparatus 113. The test results or measurement results are in particular electrically transmitted to the analysis device 200 or the control apparatus 207 thereof, and are accordingly prepared, analysed, stored and/or displayed, in particular by the display apparatus 209.

After the test has been carried out, the cartridge 100 is removed from the analysis device 200 again and is preferably disposed of.

The fluid system 103 is preferably designed as a microfluidic system. The same preferably also applies to the cartridge 100, which is in particular designed as a microfluidic cartridge.

In the present invention, the term “microfluidic” is preferably understood to mean volumes of less than 1 ml, particularly preferably less than 0.5 ml, in individual cavities or channels or in a plurality of or all of said cavities or channels.

Preferably, no external liquids have to be fed in or provided while the test is being carried out. This minimises the risk of inadvertent contamination of the surroundings or the analysis device 200. At the same time, the sensitivity to external disturbances is reduced, since no additional substances need to be introduced in addition to the sample P.

Preferably, the storage cavities 108 are closed by mechanically actuated valves 115, and not by what are known as capillary stops or the like. This also increases the robustness of the cartridge 100 and maintains its functionality.

The cartridge 100 and/or the support or main body 101 is preferably produced in an injection-moulding process, particularly preferably from polypropylene, in particular with the depressions, which are preferably only made on one side and are intended to form the cavities and channels, preferably being covered by the film or cover 102 only on one side, or on both sides if required, and said cavities and channels being formed in a desired manner as a result. However, other structural solutions are also possible.

Particularly preferably, a plurality of or different closed (gas-tight) circuits are formed on or in the cartridge 100 for different fluids, liquids, reagents F and/or for the sample P, depending on the state of the valves 115 of the fluid system 103, for example a circuit for conveying the sample (receptacle or receiving cavity 104, connection channel or outlet 104C, cavity 105, channel 114, cavity 9, channel 114, pump apparatus 112, channel 114 and back to the receptacle or receiving cavity 104 via the ventilation channel or inlet 104B) and a circuit for conveying the reagents F (a cavity 108, channel 114, cavity 107, channel 114, pump apparatus 112 and channel 114 back to the cavity 108).

A plurality or all of the circuits can preferably be operated by the same pump apparatus 112.

One or more circuits are in particular formed by the fluid system 103 together with the receptacle or receiving cavity 104, in order to transfer the sample P from the receptacle or receiving cavity 104 into the fluid system 103.

One or more circuits are preferably formed without the receptacle or receiving cavity 104, i.e. only in the fluid system 103.

The different circuits are used for example to convey the sample P, to treat the sample P with one or more reagents, in particular liquid reagents F, to feed the treated sample P to the sensor apparatus 113, to flush one or more cavities, or the like.

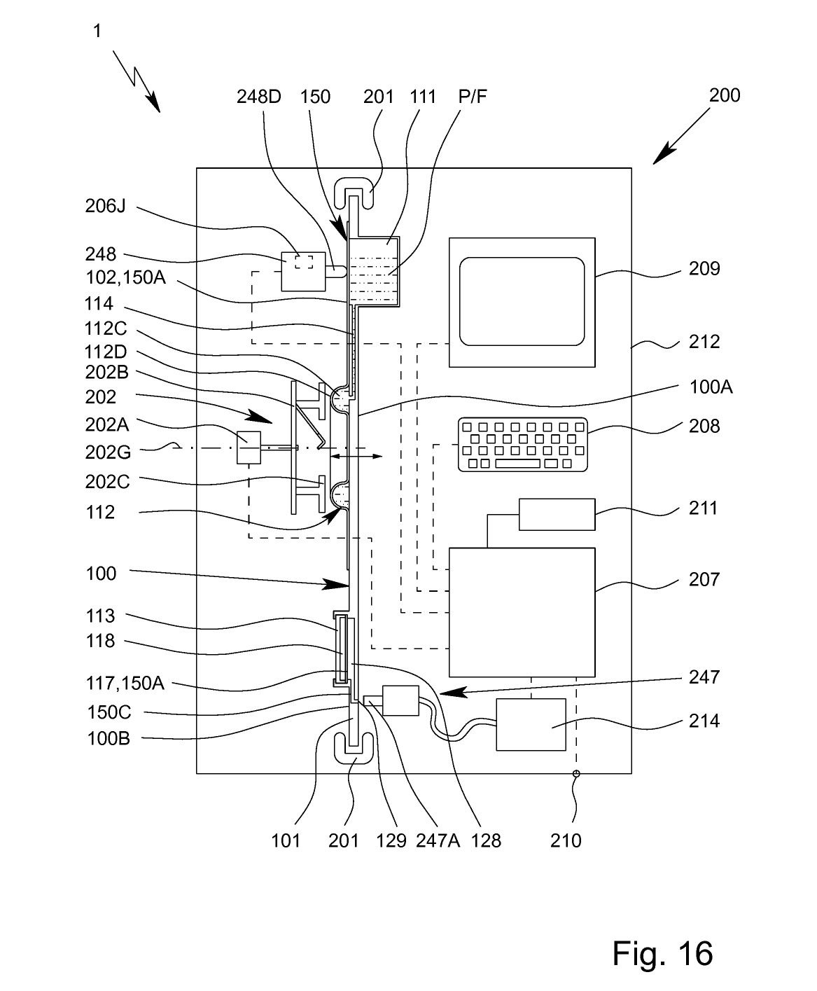

FIG. 16 shows in a schematic view similar to FIG. 3 another embodiment of further aspects of the analysis system 1, the cartridge 100 and the analysis device 200 according to the present invention. In the following only relevant differences or new aspects are emphasised, so that the previous explanations, features and description apply preferably in addition or at least in a similar manner even without repetition.

The analysis system 1 or analysis device 200 comprises an actuator 248 having an actuation element 248D acting on a manipulating element 150A of the manipulating apparatus 150 for increasing the pressure in the pump chamber 112C, in particular to raise the wall 112D, when the manipulating element 150A is actuated or depressed.

Preferably, the manipulating element 150A is formed by the layer, cover or film 102 of the cartridge 100. The cover or film 102 covers preferably also one or more channels 114 or cavities 105 to 111 of the cartridge 100 or fluid system 103 and/or the back 100B of the cartridge 100.

The manipulating element 150A is preferably membrane-like and/or covers or is associated with the collection cavity 111 in the shown embodiment.

When the manipulating element 150A is actuated or depressed, the pressure is increased in the preferably closed circuit of fluid system 103 which includes the pump chamber 112C. The pressure increase results in that the wall 112D of the pump chamber 112C is raised and/or that the pump chamber 112C is returned into its non-depressed or non-deformed form or shape.

Thus, the manipulating apparatus 150 does not have to be arranged within or below the pump chamber 112C or its wall 112D, but is arranged distant or separately in this example.

In the shown embodiment, the fluid system 103 or a channel 114 connects the collection cavity 111 with the pump chamber 112C fluidically so that the manipulating element 150A can act on the fluid system 103 for increasing the pressure in the pump chamber 112C, when the manipulating element 150A is actuated or depressed. It is noted that the manipulating element 150A is shown in the non-actuated or non-depressed state in FIG. 16.

The analysis system 1 or analysis device 200 may be provided with the actuator 248 for actuating the manipulating element 150A alternatively or additionally to the pressurized gas supply 214 and respective connection apparatus 247/connection element 247A.

The proposed method of increasing the pressure in the pump chamber 112C by actuating or depressing a preferably flexible or membrane-like manipulating element 150A acting on a separate cavity 111 or the like of the fluid system 103 allows a very simple realisation and operation.

Optionally, the analysis system 1 or analysis device 200 or its actuator 248 may be provided with a force sensor 206J to measure the force acting on the manipulating element 150A for determining the pressure acting on or in the fluid system 103 and/or on or in the pump chamber 112C. In this measurement, the actuation distance or depression may be measured as well in order to get additional information and/or allow better or more precise determination of the pressure within the fluid system 103/pump chamber 112C.

The cartridge 100 may comprise alternatively or additionally to the manipulation apparatus 150 for acting on the pump chamber 112C or its wall 112D (as described with regard to the embodiment according to FIG. 16 above or with regard to the other embodiments previously) a (further) manipulation apparatus 150 here preferably with an actuating element 150A associated with or acting on the sensor apparatus 113. In particular, the actuating element 150A of the further manipulation apparatus 150 forms a sensor cover 117 and/or delimits a sensor compartment 118 formed above the sensor apparatus 113 in or at the cartridge 100. Preferably, the manipulation element 150A/sensor cover 117 when actuated can be moved towards or onto the sensor apparatus 113 and/or decrease the sensor compartment 118 formed above the sensor apparatus 113 in or at the cartridge 100.

The manipulating element 150A associated with the sensor apparatus 113 is preferably membrane-like and/or flexible.

The manipulating element 150A is preferably actuated or depressed by applying the working medium, in particular a gas or air pressure, on the side opposite to the sensor apparatus 113 in particular in the associated pressure chamber 128.

The (further) manipulating apparatus 150 comprises preferably a separate connection 129 for applying or supplying the working medium or pressurized gas/air to the manipulation element 150A, sensor cover 117 and/or pressure chamber 128. This is preferably realized as already discussed above.

Preferably, the manipulating element 150A returns to its initial form or position distant to the sensor apparatus 113 when the connection 129 or connection channel 150C is aerated, in particular due to resilience. However, other constructional solutions are possible as well.

Thus, the cartridge 100 may comprise multiple manipulation apparatus 150 which wall or are actuated independently and preferably pneumatically and/or which comprise separate connections 129.

Individual aspects and features of the present invention and individual method steps may be implemented independently from one another, but also in any desired combination and/or order.

In particular, the present invention relates also to any one of the following aspects which can be combined with any one of the previous aspects and claims, but can also be realized independently:

1. Cartridge 100 for testing an in particular biological sample P, the cartridge 100 comprising a fluid system 103 having a plurality of channels, and the cartridge 100 comprising a manipulating apparatus 150 that is flexible at least in part, a working medium, in particular gas, being or being able to be admitted to the manipulating apparatus 150 in order to actuate the manipulating apparatus 150, the cartridge 100 comprising a connection 129 by means of which the cartridge 100 and/or manipulating apparatus 150 can be supplied with or driven by the working medium, characterized in that the cartridge 100 comprises a planar seal 129C in order to seal a fluidic connection between the connection 129 and an analysis device 200.
2. Cartridge according to aspect 1, characterised in that the manipulating apparatus 150 comprises a pressure chamber 150B, a distribution channel 150D and a plurality of feed channels 150E, it preferably being possible for the working medium to be fed from the distribution channel 150D to the pressure chamber 150B via the feed channels 150E, and/or the distribution channel 150D preferably being arranged directly below the pressure chamber 150B in a plan view of the cartridge 100.
3. Cartridge according to aspect 1 or 2,characterised in that the cartridge 100 comprises a pump apparatus 112 for conveying the sample P and/or a fluid, the pump apparatus 112 preferably comprising a pump chamber 112C having a flexible wall 112D, it being possible for the sample P and/or the fluid to be conveyed by deforming the wall 112D, and/or the manipulating apparatus 150, in particular the pressure chamber 150B, being arranged at least in part below the pump chamber 112C and/or being designed to enlarge the pump chamber 112C again following deformation.
4. Cartridge according to any one of the preceding aspects, characterised in that the cartridge 100 comprises a sensor apparatus 113 for testing the sample P or a component thereof, the manipulating apparatus 150 preferably being designed to hold the sample P and/or the fluid on the sensor apparatus 113 at least temporarily and/or in portions and/or to seal the sensor apparatus 113 at least temporarily and/or in portions.
5. Cartridge according to any one of the preceding aspects, characterised in that the manipulating apparatus 150 comprises a manipulating element 150A that is flexible and/or elastically deformable at least in part, the manipulating element 150A preferably being formed by a layer or film and/or being arranged between the wall 112D and/or the sensor apparatus 113 on one side and a support 101 of the cartridge 100 and/or a film 102 of the cartridge 100 on the other side.
6. Cartridge according to any one of the preceding aspects, characterised in that the manipulating apparatus 150 and/or the manipulating element 150A is planar, curved, arcuate and/or designed as a raised portion on the cartridge 100 and/or a support 101 of the cartridge 100 and/or is designed as a membrane.
7. Cartridge according to any one of the preceding aspects, characterised in that the cartridge 100 comprises an at least substantially flat and/or card-like support 101, the fluid system 103, the pump apparatus 112 and/or the manipulating apparatus 150 preferably being formed at least in part by depressions and/or raised portions in and/or on the support 101.
8. Cartridge according to any one of the preceding aspects, characterised in that the seal 129C is elastically deformable.
9. Cartridge according to any one of the preceding aspects, characterised in that the seal 129C is made of foamed plastics material and/or in particular of foamed polyurethane or polyethylene.
10. Cartridge according to any one of the preceding aspects, characterised in that the support 101 is made of plastics material, in particular polypropylene.
11. Cartridge according to any one of the preceding aspects, characterised in that the seal 129C is indirectly or directly bonded, in particular by adhesion, to the support 101, preferably over the entire surface thereof.
12. Cartridge according to any one of the preceding aspects, characterised in that the seal 129C is recessed in the region of the manipulating apparatus 150, pump apparatus 112 and/or sensor apparatus 113 and/or comprises a recess (in each case).
13. Cartridge according to any one of the preceding aspects, characterised in that the seal 129C extends around the connection 129, in particular a connection opening 129A in the connection 129, and/or comprises an opening, the opening preferably being arranged coaxially with the connection 129 and/or connection opening 129A.
14. Cartridge according to any one of the preceding aspects, characterised in that the cartridge 100 comprises a plurality of manipulating apparatuses 150 and/or a plurality of connections 129, the manipulating apparatuses 150 preferably each having a separate connection 129 and/or it being possible for the working medium to be admitted to each manipulating apparatus separately and/or for each manipulating apparatus to be driven separately by the working medium.
15. Cartridge according to aspect 14, characterised in that the seal 129C is assigned to several or all of the connections 129 and/or is designed to seal several or all of the connections 129 while the working medium is being fed in.

1-30. (canceled)

31. A cartridge for testing a sample, comprising:
a main body and a fluid system having a plurality of channels;
a manipulating apparatus that is flexible at least in part;
a working medium configured to be admitted to the manipulating apparatus in order to actuate the manipulating apparatus; and
a connection by means of which at least one of the cartridge and manipulating apparatus can be supplied with the working medium,
wherein the cartridge comprises a planar seal arranged on the main body of the cartridge in order to seal a fluidic connection between the connection and an analysis device, the seal being comprised of foamed plastics material, and the foamed plastics material having a lower indentation hardness than an indentation hardness of the main body.

32. A cartridge for testing a sample, comprising:
a fluid system having a plurality of channels;
at least one valve for controlling the flow of the sample through the fluid system, the valve comprising a valve chamber and a wall that is flexible at least in part, the valve being configured to be actuated by deforming the wall;
a manipulating apparatus that is flexible at least in part;
a working medium configured to be admitted to the manipulating apparatus in order to actuate the manipulating apparatus; and
a connection by means of which at least one of the cartridge and manipulating apparatus can be supplied with the working medium,
wherein the cartridge comprises a seal of the cartridge to seal a fluidic connection between the connection and an analysis device, the valve comprising at least one of a cover and a layer, the cover or layer covering the wall on a side remote from the valve chamber, and the cover or layer being at least one of made of the same material as or in one piece with the seal.

33. The cartridge according to claim 32, wherein the seal is comprised of foamed plastics material.

34. The cartridge according to claim 33, wherein the foamed plastics material has a lower indentation hardness than an indentation hardness of a main body of the cartridge.

35. The cartridge according to claim 31, wherein the cartridge comprises a pump apparatus for conveying the sample, wherein the manipulating apparatus is arranged at least in part below the pump apparatus.

36. The cartridge according to claim 35, wherein the manipulating apparatus is designed to enlarge the pump chamber following deformation.

37. The cartridge according to claim 31, wherein the seal extends around a connection opening in the connection.

38. A cartridge for testing a sample, comprising:
a fluid system having a plurality of channels and cavities;
a pump apparatus for conveying the sample, the pump apparatus comprising a pump chamber which is elastically deformable or compressible at least in part by means of at least one of a pump head and contact elements, in order to convey the sample; and
a manipulating apparatus configured to raise a wall of the pump chamber from a main body of the cartridge, further comprising at least one of the following features:
a) at least one of the cartridge and manipulating apparatus comprises an external connection for supplying pressurized gas as a working medium to the manipulating apparatus, and
b) at least one of the cartridge and manipulating apparatus comprises a manipulating element acting on the fluid system for increasing the pressure in the pump chamber to raise the wall when the manipulating element is actuated or depressed.

39. The cartridge according to claim 38, wherein the manipulating apparatus comprises a pressure chamber, a distribution channel and a plurality of feed channels.

40. The cartridge according to claim 39, wherein the distribution channel is arranged directly below the pressure chamber in a plan view of the cartridge.

41. The cartridge according to claim 38, wherein the manipulating apparatus comprises a manipulating element that is flexible or elastically deformable at least in part.

42. The cartridge according to claim 38, wherein the manipulating element is configured as a membrane or formed by at least one of a cover, a layer and a film.

43. The cartridge according to claim 42, wherein the cover, layer, film or membrane covers one or more channels or cavities of at least one of the cartridge and the fluid system.

44. The cartridge according to claim 38, wherein the manipulating element covers a cavity, separate from the pump chamber, but connected with the pump chamber via one or more channels so that the pressure in the pump chamber is increased to raise the wall of the pump chamber when the manipulating element is actuated or depressed.

45. The cartridge according to claim 31, wherein the cartridge comprises a plurality of manipulating apparatuses and a plurality of connections.

46. The cartridge according to claim 45, wherein the manipulating apparatuses each have a separate connection.

47. The cartridge according to claim 46, wherein the seal is assigned to at least a plurality of the connections.

48. The cartridge according to claim 31, wherein the cartridge comprises a sensor apparatus for testing the sample, wherein the manipulating apparatus is configured to at least one of seal, hold and reduce the sample on the sensor apparatus at least temporarily or partially.

49. An analysis system for testing a sample, comprising:
a cartridge for receiving the sample; and
an analysis device for performing the testing the sample in the cartridge,
wherein the cartridge comprises a fluid system having a plurality of channels and cavities, and a pump apparatus for conveying the sample,
wherein the pump apparatus comprises a pump chamber which is elastically deformable or compressible at least in part by means of a pump head or contact elements, in order to convey the sample, and
wherein the analysis device comprises an actuator for actuating or depressing a manipulating element of the cartridge in order to increase at least one of a pressure in the cartridge or a pressure acting on a pressure chamber during or before pumping the sample within the cartridge.

50. The analysis system according to claim 49, wherein the analysis device comprises a force sensor for measuring the force acting on the manipulation element for determining the pressure in the pump chamber.
